(19) United States
(12) Patent Application Publication
(10) Pub. No.: US 2010/0162836 A1
(43) Pub. Date: Jul. 1, 2010

(54) ROTATING TYPE POWER GAIN MACHINE

(75) Inventor: Ming-Chin CHIU, Changhua City (TW)

Correspondence Address: FOLEY AND LARDNER LLP;SUITE 500, 3000 K STREET NW, WASHINGTON, DC, 20007, US

(73) Assignee: CENTURY POWER CO., LTD.

(21) Appl. No.: 12/606,498

(22) Filed: Oct. 27, 2009

(30) Foreign Application Priority Data
Dec. 31, 2008 (TW) 097151668

(51) Int. Cl. F16H 33/02

(52) U.S. Cl. 74/64

(57) ABSTRACT

A rotating type power gain device includes at least two power gain devices driven by a driving device to rotate on a base. Each of the power gain devices can be controlled in an alternating cycling mode such that, when it reaches a first angular position, it is unlocked from the driving device, and is locked to a rotating device so as to rotate downwardly by gravity, when it rotates downwardly to an exchanging position, the other of the power gain devices is rotated by the driving device to the first angular position, and when it rotates to a second angular position disposed below the first angular position, it is unlocked from the rotating device, and is locked to the driving device. Downward rotation of the power gain devices results in conversion of the gravitational potential energy of the power gain devices into rotational kinetic energy.

### CROSS-REFERENCE TO RELATED APPLICATION

This application claims priority of Taiwanese Application No. 097151668, filed on Dec. 31, 2008.

### BACKGROUND OF THE INVENTION

1. Field of the Invention

This invention relates to a power gain machine, and more particularly to a rotating type power gain machine capable of converting gravitational potential energy into rotational kinetic energy.

2. Description of the Related Art

A high torque is required to be outputted from an engine in an automobile to facilitate acceleration of the automobile, or from a power plant to promote the power-generating efficiency of the power plant. Although wind energy can be converted into rotational kinetic energy to provide a high-torque output, wind condition is unsteady. Therefore, it is desirable to output a continuous and steady high torque from a rotating device.

### SUMMARY OF THE INVENTION

The object of this invention is to provide a rotating type power gain machine that can provide a continuous and steady high-torque output.

According to an aspect of this invention, there is provided a power gain machine comprising:

a base;

a driving device disposed on the base;

a rotating device disposed rotatably on the base;

first, second, and third power gain devices disposed rotatably on the base and locked releasably on the driving device and the rotating device such that, each of the first, second, and third power gain devices is driven by the driving device to rotate relative to the base when locked to the driving device; and

a control device for controlling the operation of the first, second, and third power gain devices in an alternating cycling mode such that : each of the first, second, and third power gain devices is locked to one of the driving device and the rotating device and is unlocked from the other of the driving device and the rotating device at any time during the alternating cycling mode; at least one of the first, second, and third power gain devices is locked to the driving device, and at least one of the first, second, and third power gain devices is locked to the rotating device at any time during the alternating cycling mode; the first, second, and third power gain devices are alternately unlocked from the driving device at a first angular position at different times so that each of the first, second, and third power gain devices can rotate downwardly from the first angular position to a second angular position disposed below the first angular position by gravity when locked to the rotating device; the first, second, and third power gain devices are alternately locked to the driving device at the second angular position at different times; when one of the first, second, and third power gain devices reaches the second angular position, one of the remaining two of the first, second, and third power gain devices is rotated to a balance position diametrically opposite to the second angular position so as to maintain a balance state therebetween; and just before one of the first, second, and third power gain devices locked to the rotating device is rotated to the second angular position, one of the remaining two of the first, second, and third power gain devices is rotated to the first angular position.

Since at least one of the firs, second, and third power gain devices is co-rotate with the rotating device at any time during the alternating cycling mode, a continuous and steady torque output can be provided.

Furthermore, when each of the first, second, and third power gain devices rotates downwardly from the first angular position by gravity, the gravitational potential energy thereof can be converted into rotational kinetic energy, thereby resulting a high-torque output from the rotating device.

According to another aspect of this invention, there is provided a power gain machine comprising:

a base;

a driving device disposed on the base;

a rotating device disposed rotatably on the base;

two power gain devices disposed rotatably on the base and locked releasably on the driving device and the rotating device such that, each of the power gain devices is driven by said driving device to rotate relative to the base when locked to the driving device; and

a control device for controlling the operation of the devices in an alternating cycling mode such that: each of the power gain devices is locked to one of the driving device and the rotating device and is unlocked from the other of the driving device and the rotating device at any time during the alternating cycling mode; the power gain devices are alternately unlocked from the driving device at a first angular position at different times so that each of the power gain devices can rotate downwardly from the first angular position to a second angular position disposed below the first angular position by gravity when locked to the rotating device; the power gain devices are alternately locked to the driving device at the second angular position at different times; and just before one of the power gain devices locked to the rotating device rotates to the second angular position, the other of the power gain devices is rotated by the driving device to the first angular position.

According to still another aspect of this invention, there is provided a method for controlling the operation of a power gain machine, comprising the steps of:

(A) in an alternating cycling mode, rotating a first power gain device to a first angular position by means of a driving device such that the first power gain device is locked to the driving device and unlocked from a rotating device, simultaneously allowing a second power gain device to rotate downwardly to an exchanging position by gravity such that the second power gain device is unlocked from the driving device and locked to the rotating device, and simultaneously co-rotating a third power gain device with the first power gain device such that the third power gain device is locked to the driving device and unlocked from the rotating device;

(B) unlocking the first power gain device from the driving device, and locking the first power gain device to the rotating device so as to allow the first power gain device to rotate downwardly from the first angular position by gravity;

(C) adjusting the speed of a driving motor of the driving device such that, when the second power gain device reaches a second angular position, the third power gain device is rotated to a balance position to thereby align with the second power gain device, thus maintaining the second and third power gain devices in a balance state;

(D) locking the second gain device to the driving device and unlocking the second gain device from the rotating device; and

(E) rotating the second and third power gain devices for a predetermined revolutions by means of the driving device such that, just before the first power gain device reaches the exchanging position, the speed of the driving motor of the driving device is adjusted to allow the third power gain device to rotate to the first angular position when the first power gain device reaches the exchanging position.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an assembled perspective view of the preferred embodiment of a rotating type power gain machine according to this invention;

FIG. 2 is another assembled perspective view of the preferred embodiment viewed at a different angle;

FIG. 3 is a fragmentary exploded perspective view of the preferred embodiment, a base being removed for the sake of brevity;

FIG. 4 is a fragmentary exploded perspective view of the preferred embodiment, illustrating a rotating device, a first power gain device, a control unit, and a rotary disk;

FIG. 5 is a fragmentary exploded perspective view of the preferred embodiment, illustrating a first transmission member, a second power gain device, a second transmission member, a third power gain device, a pivot shaft, a main driving gear, a main driven gear, and a driving motor;

FIG. 6 is a sectional view of the preferred embodiment;

FIG. 7 is a fragmentary sectional view of the preferred embodiment, illustrating three detecting members and a control unit;

FIG. 8 is a fragmentary perspective view of a control device of the preferred embodiment;

FIG. 9 is a perspective view of the second transmission member;

FIG. 10 is a front view of the preferred embodiment, illustrating the connection relationships between the first power gain device and the first transmission member and between the first power gain device and the rotating device, and illustrating how a pushing member of the first power gain device is at a disengagement position whereat a brake ring is coaxial with and spaced apart from first brake shoes;

FIG. 11 is a fragmentary front view of the preferred embodiment, illustrating the connection relationship between a first gear unit and the pushing member;

FIG. 12 is a fragmentary front view of the preferred embodiment, illustrating how the pushing member of the first power gain device is at a first engagement position whereat the brake ring is not axial with the first brake shoes and presses against lower portions of the first brake hoes;

FIG. 13 is a fragmentary front view of the preferred embodiment, illustrating how the pushing member of the first power gain device is at a second engagement position whereat the brake ring is not axial with the first brake shoes and presses against upper portions of the first brake hoes;

FIG. 14 is a fragmentary front view of the preferred embodiment, illustrating how two brake plates are spaced apart from a wall defining a first annular groove;

FIG. 15 is a schematic sectional view illustrating the connection relationship among one of the brake plates and a body and a sliding plate of a sliding seat;

FIG. 16 is a view similar to FIG. 14 bust illustrating how the two brake plates are moved away from each other to press against the wall defining the first annular groove;

FIG. 17 is a fragmentary rear view of the preferred embodiment, illustrating the connection relationships between the second power gain device and the first transmission member and between the second power gain device and the rotating device;

FIG. 18 is a fragmentary rear view of the preferred embodiment, illustrating the connection relationships between the third power gain device and the second transmission member and between the third power gain device and the rotating device;

FIG. 19 is a view similar to FIG. 12 but illustrating how a pushing member of the third power gain device is at a first engagement position whereat a brake ring of the third power gain device is moved by a pushing member of the third power gain device to press against a lower third brake shoe;

FIG. 20 is a view similar to FIG. 13 but illustrating how the pushing member of the third power gain device is at a second engagement position whereat the brake ring of the third power gain device is moved by the pushing member of the third power gain device to press against an upper third brake shoe;

FIG. 21 is a fragmentary perspective view of the preferred embodiment, illustrating the connection relationship among a fixed ring, the pivot shaft, and the first power gain device;

FIG. 22 is a fragmentary perspective view of the preferred embodiment, illustrating the connection relationship among a rotary disk, the pivot shaft, and the first power gain device;

FIG. 23 is a fragmentary perspective view of the preferred embodiment, illustrating the connection relationship among the first power gain device, the first transmission member, and the rotating device;

FIG. 24 is a schematic front view of the preferred embodiment, illustrating how the first, second, and third power gain devices are maintained in a balance state when the driving device is not operated;

FIG. 25 is a control flow chart of the preferred embodiment;

FIG. 26A is a detailed flow chart of a power-on mode of the preferred embodiment;

FIGS. 26B and 26C are detailed flow charts of an initial load-rotating mode of the preferred embodiment;

FIGS. 26D and 26E are detailed flow charts of an alternating cycling mode of the preferred embodiment;

FIG. 27 is a schematic view illustrating inner and outer clutches of the first power gain device, each of which is in a locking state;

FIG. 28 is a schematic view illustrating inner and outer clutches of the second power gain device, each of which is in a locking state;

FIG. 29 is a schematic view illustrating inner and outer clutches of the third power gain device, each of which is in a locking state;

FIG. 30 is a schematic view illustrating the power gain machine in the initial load-rotating mode, the first power gain device at a first angular position, and the second power gain at an exchanging position;

FIG. 31 is a schematic view illustrating the power gain machine in the initial load-rotating mode, the second power gain device at a second angular position, and the third power gain device at a balance position;

FIG. 32 is a schematic view illustrating the power gain machine in the alternating cycling mode, the third power gain device at the first angular position, and the first power gain device at the exchanging position;

FIG. 33 is a schematic view illustrating the power gain machine in the alternating cycling mode, the first power gain device at the second angular position, and the second power gain device at the balance position;

FIG. 34 is a schematic view illustrating the power gain machine in the alternating cycling mode, the second power gain device at the first angular position, and the third power gain device at the exchanging position;

FIG. 35 is a detailed flow chart of a power-off mode of the preferred embodiment;

FIG. 36 is a schematic view illustrating the power gain machine in the power-off mode, the first power gain device at the first angular position, and the second power gain device at the exchanging position; and

FIG. 37 is a schematic view illustrating the positions of the first, second, and third power gain devices when the driving motor is stopped during the power-off mode.

### DETAILED DESCRIPTION OF THE PREFERRED EMBODIMENT

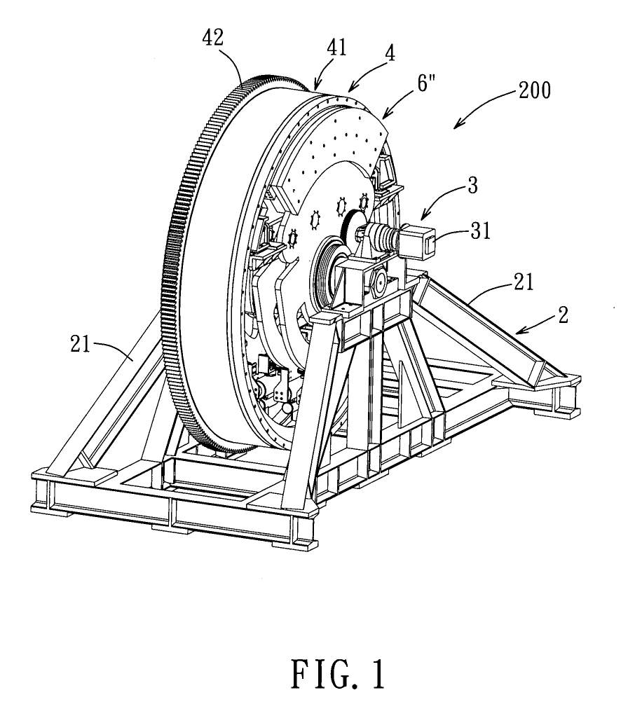

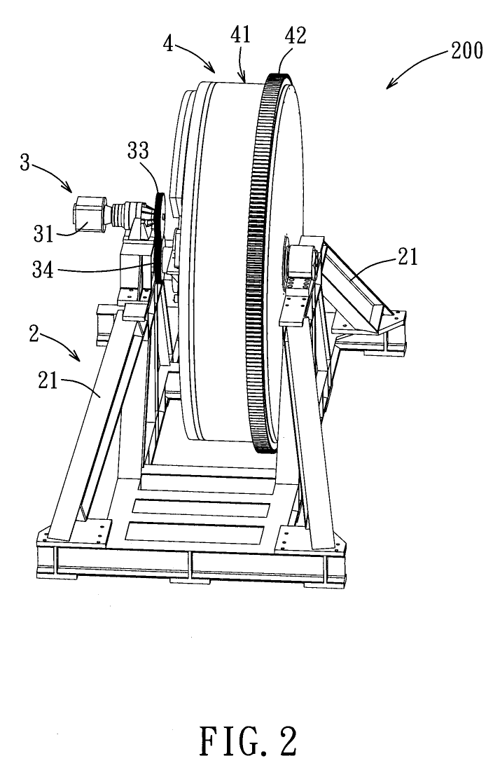

Referring to FIGS. 1, 2, and 3, the preferred embodiment of a rotating type power gain machine 200 according to this invention is used to provide a power to an energy-generating device (not shown). In this embodiment, the energy-generating device is exemplified using a generator. The rotating type power gain machine 200 includes a base 2, a driving device 3, a rotating device 4, a plurality of power gain devices, a rotary disk 7, and a control device 8. In this embodiment, the power gain devices include a first power gain device 6, a second power gain device 6′, and a third power gain device 6″.

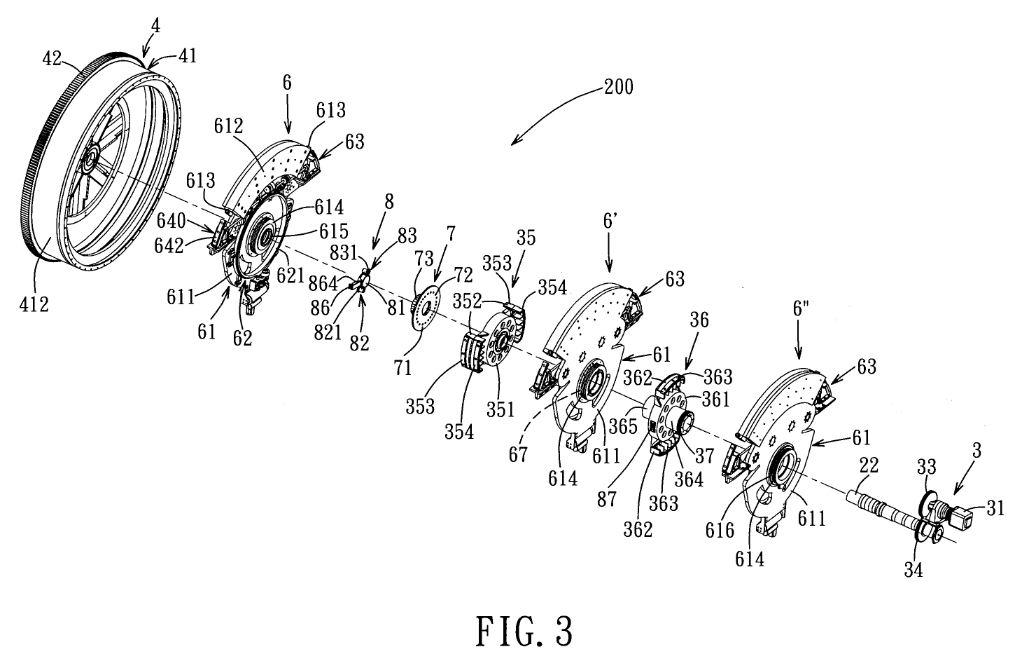

Referring to FIGS. 3, 4, 5, 6, and 9, the driving device 3 is disposed in front of the rotating device 4. The base 2 is disposed on a support surface (not shown), such as the ground surface, and includes a pair of front and rear support frames 21 each formed with a hole 211 at a top end thereof, and a pivot shaft 22. The pivot shaft 22 extends through the through holes 211 in the front and rear support frames 21 along a front-to-rear direction.

The driving device 3 includes a driving motor 31 disposed on the top end of the front support frame 21, a main driving gear 33 sleeved fixedly on an output shaft of the driving motor 31, a main driven gear 34 sleeved rotatably on the pivot shaft 22 and meshing with the main driving gear 33, a first transmission member 35, and a second transmission member 36. In this embodiment, the driving motor 31 is a 1.5-horsepower servomotor. The first transmission member 35 includes a sleeve 351 sleeved rotatably on the pivot shaft 22, two wings 352 projecting respectively from two opposite sides of the sleeve 351 along a first direction, two first brake shoes 353 disposed respectively and fixedly on rear ends of the wings 352 and diametrically opposite to each other, and two second brake shoes 354 disposed respectively and fixedly on front ends of the wings 352 and diametrically opposite to each other. The second transmission member 36 is similar in construction to the first transmission member 35, and includes a sleeve 361 sleeved rotatably on the pivot shaft 22, two wings 362 projecting respectively from two opposite sides of the sleeve 361 along a second direction perpendicular to the first direction (A), two third brake shoes 363 disposed respectively and fixedly on front ends of the wings 362 and diametrically opposite to each other, a first tube body 364 formed on a front end of the sleeve 361, and a second tube body 365 formed on a rear end of the sleeve 361. The first and second tube bodies 364, 365 are formed integrally with the sleeve 361. A plurality of bearings 32 are disposed between the pivot shaft 22 and an assembly of the sleeve 361 and the first and second tube bodies 364, 365.

The first tube body 364 of the second transmission member 36 is connected fixedly to and coaxial with a rear side of the main driven gear 34 . The sleeve 351 of the first transmission member 35 is connected fixedly to and coaxial with the second tube body 365 of the second transmission member 36. When the driving motor 31 is operated, the main driving gear 33 rotates the main driven gear 34 and, thus, the first and second transmission members 35, 36. In this embodiment, the sleeve 351 and the wings 352 of the first transmission member 35 are made of stainless steel or other metal having low magnetic conductivity. The sleeve 361, the wings 362, and the first and second tube bodies 364, 365 of the second transmission member 36 are made of metal.

The rotating device 4 is used to provide the power to the generator, and includes a rotary wheel 41 sleeved rotatably on the pivot shaft 22, and an external gear 42 disposed for connection with the generator. The rotary wheel 41 has a wheel body 411 disposed in proximity to the rear support frame 21, and a surrounding wall 412 extending forwardly from an outer periphery of the wheel body 41. A plurality of bearings 43 are disposed between the wheel body 411 and the pivot shaft 22. The surrounding wall 412 has an inner surface formed with first, second, and third annular grooves 413, 414, 415 spaced apart from each other. The second annular groove 414 is disposed in front of the first annular groove 413, and behind the third annular groove 415.

The second power gain device 6′ is disposed between and spaced apart from the first and third power gain devices 6, 6″ along an axial direction of the pivot shaft 22 (i.e., the front-to-rear direction).

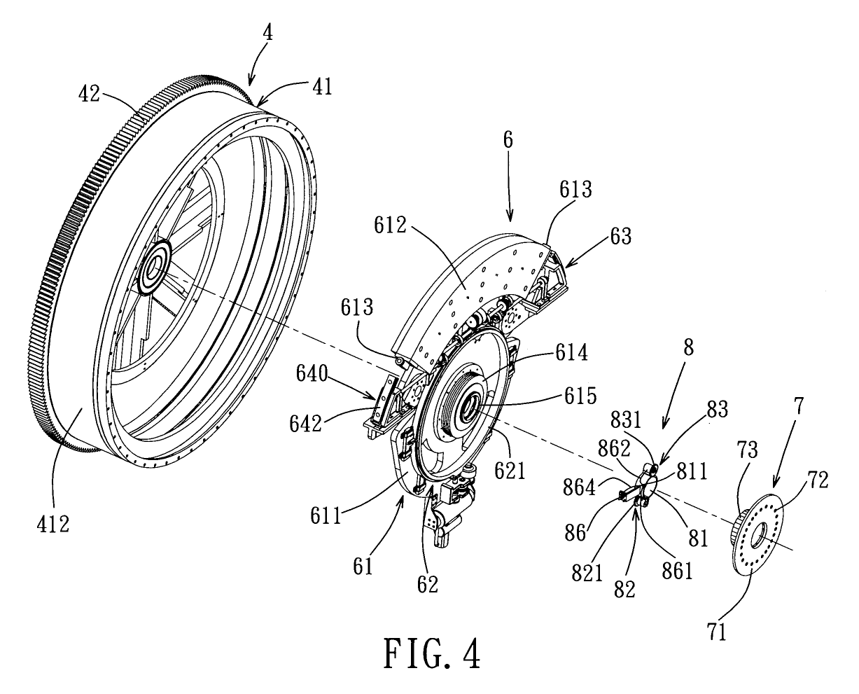

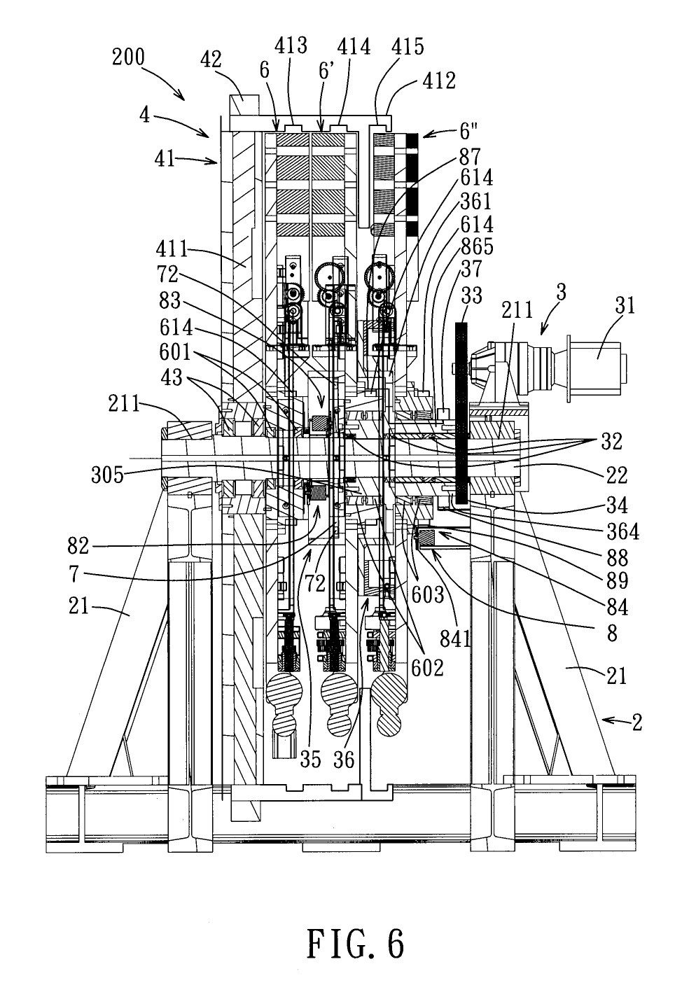

Referring to FIGS. 4, 6, 10, 12, and 13, the first power gain device 6 is disposed between the first transmission member 35 of the driving device 3 and the wheel body 411 of the rotary wheel 41 of the rotating device 4. The first power gain device 6 includes a rotatable body 61 sleeved rotatably on the pivot shaft 22, an inner clutch 62, and an outer clutch 63. A plurality of bearings 601 (see FIG. 6) are disposed between the rotatable body 61 and the pivot shaft 22. The rotatable body 61 includes a plat body 611, a counterweight portion 612 disposed on an outer end of the plate body 511, and two sliding wheels 613 disposed respectively on two opposite sides of the counterweight portion 612. The sliding wheels 613 are disposed movably within the first annular groove 413 in the rotary wheel 41. The inner clutch 62 is operable to be locked to or unlocked from the first transmission member 35 of the driving device 3, and includes a brake ring 621 disposed around the first transmission member 35, and a plurality of sliding blocks 622 projecting from an outer peripheral surface of the brake ring 621. The sliding blocks 622 are retained movably on the plate body 611 by a plurality of U-shaped positioning members 623.

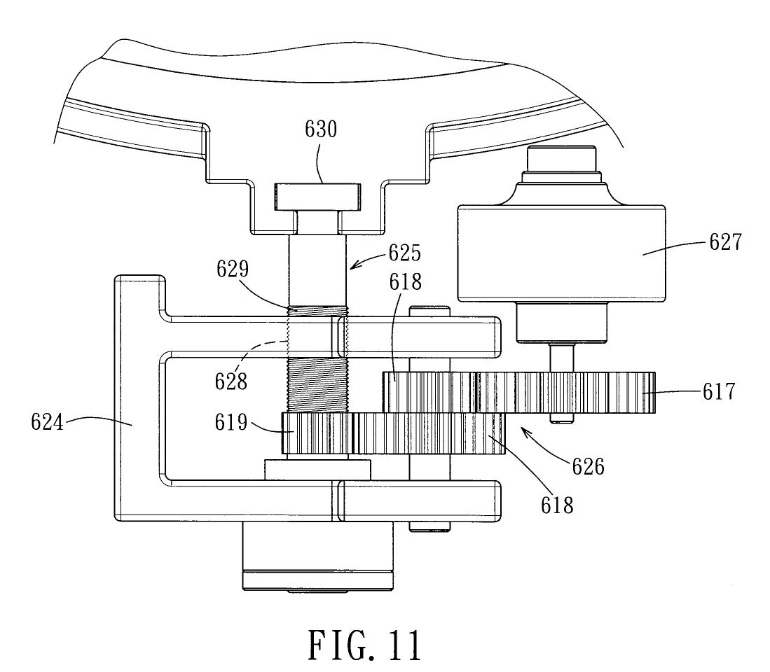

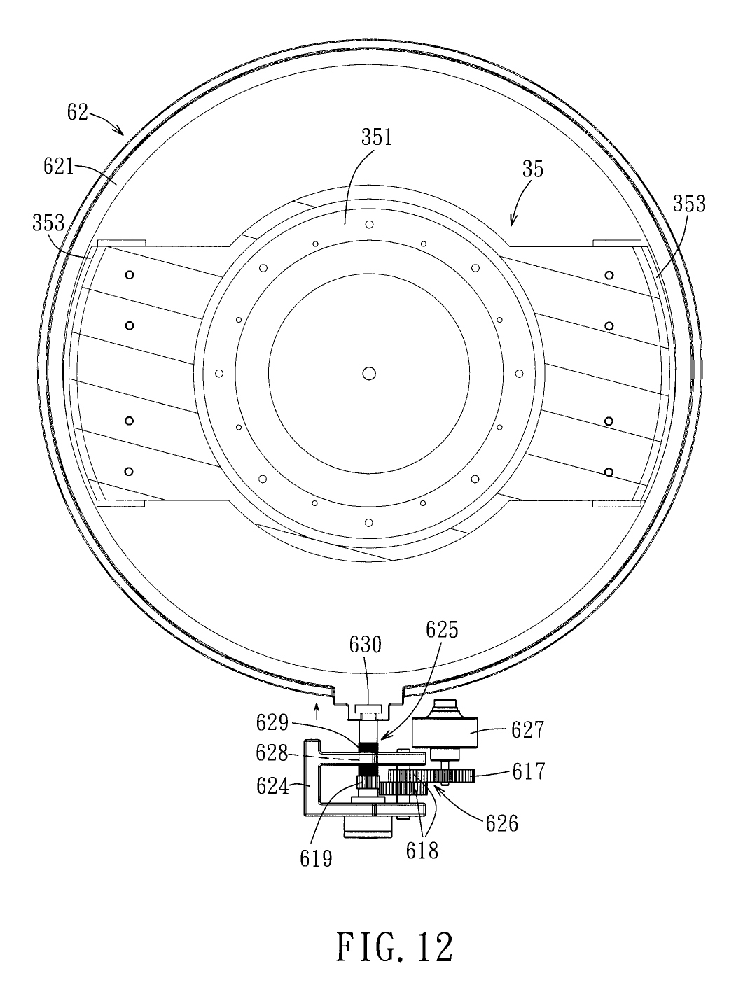

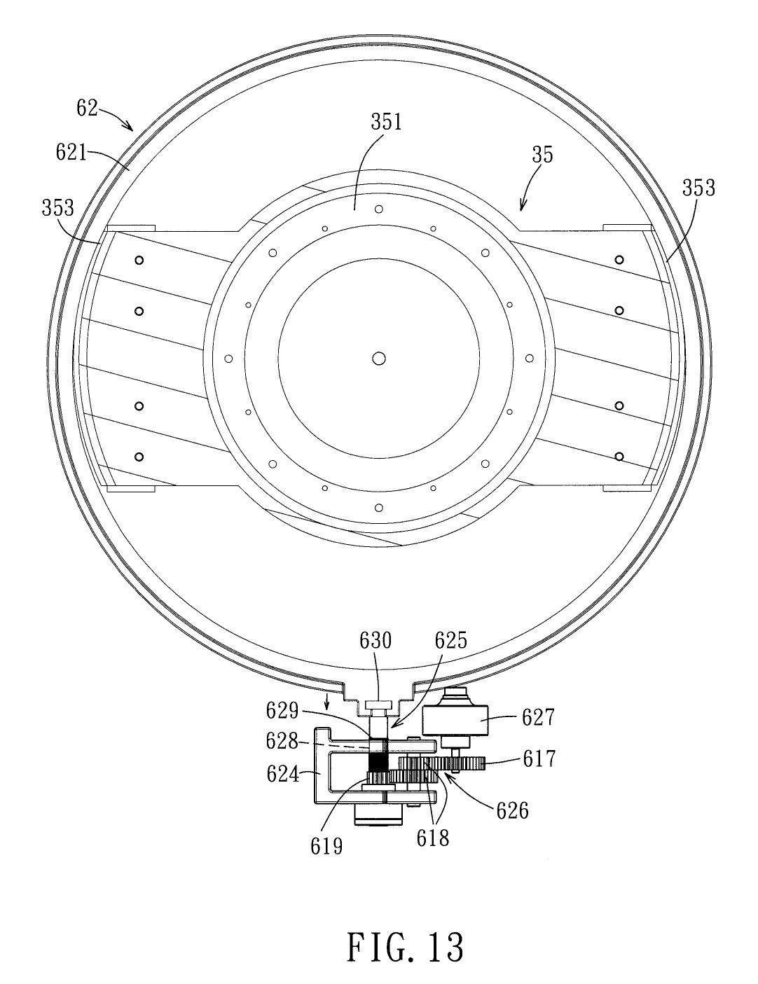

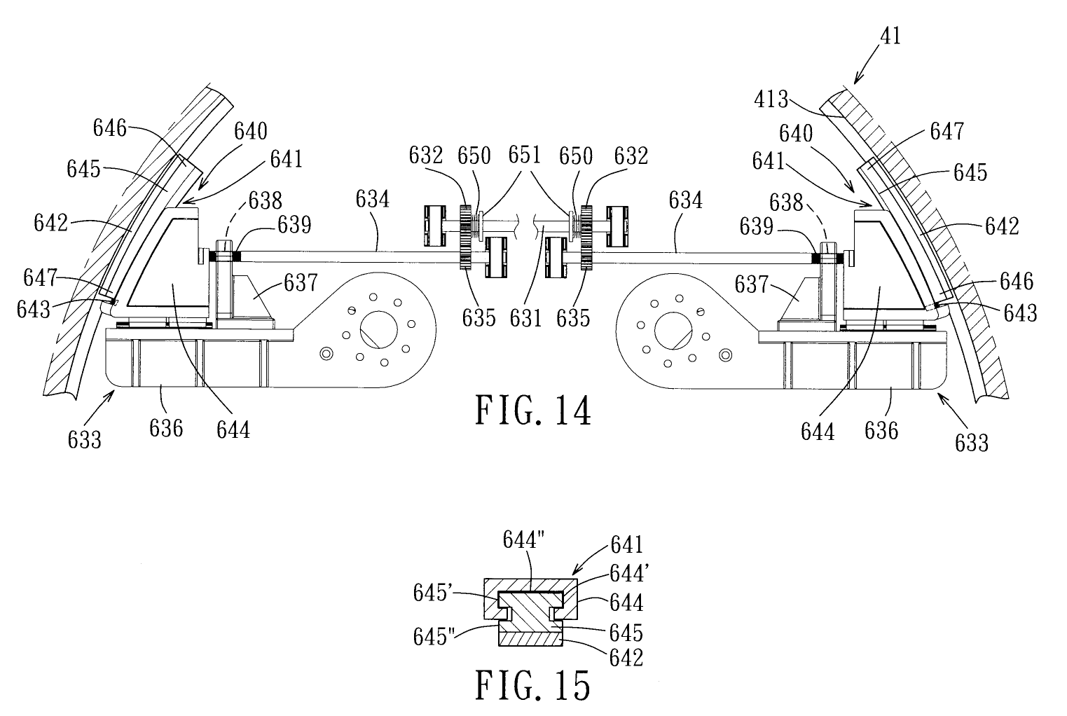

With further reference to FIG. 11, the inner clutch 62 further includes a mounting frame 624 disposed fixedly on the plate body 611, a pushing member 625, a first gear unit 626, and a first motor 627. The mounting frame 624 is formed with a threaded hole 628. The pushing member 625 has an externally threaded section 629 engaging the threaded hole 628 in the mounting frame 624, and an end disposed fixedly within a retaining groove 630 in the brake ring 621. The first gear unit 626 is connected between the pushing member 625 and the first motor 627. The first gear unit 626 includes a driving gear 617 sleeved fixedly on an output shaft of the first motor 627, a two-stepped first driven gear disposed pivotally on the mounting frame 624 and consisting of a pair of upper and lower gear portions 618 having different diameters, and a second driven gear 619 sleeved fixedly on the pushing member 625. The driving gear 617 meshes with the upper gear portion 618 of the first driven gear. The second driven gear 619 meshes with the lower gear portion 618 of the first driven gear. The first motor 627 is a pneumatic motor for rotating the driving gear 617 in two directions. When the first motor 627 is operated to activate the first gear unit 626, since the externally threaded section 629 of the pushing member 625 engages the threaded hole 628 in the mounting frame 624, the pushing member 625 moves relative to the mounting frame 624 along a longitudinal direction thereof among a disengagement position shown in FIG. 10 and a pair of first and second engagement positions shown respectively in FIGS. 12 and 13. When the pushing member 625 is at the first or second engagement position, the brake ring 621 is not coaxial with the sleeve 351 so as to press against the first brake shoes 353. When the pushing member 625 is at the disengagement position, the brake ring 621 is coaxial with and spaced apart from the sleeve 351 the first brake shoes 353. As such, the inner clutch 62 is convertible between a locking state shown in FIGS. 12 and 13, and a release state shown in FIG. 10.

With reference to FIGS. 4, 10, and 14, the outer clutch 63 is operable to be locked to or unlocked from the rotary wheel 41 of the rotating device 4. The outer clutch 63 includes a driving rod 631 journalled on the plate body 611, two first driving gears 632 sleeved respectively and fixedly on two opposite end portions of the driving rod 631, two mounting seats 633 disposed respectively and fixedly on two opposite sides of the plate body 611, two driven rods 634 extending respectively and rotatably through the mounting seats 633, and two second driving gears 635 sleeved respectively and fixedly on the driven rods 634. Each of the mounting seats 633 includes a first seat body 636 disposed fixedly on the plate body 611, and a second seat body 637 disposed fixedly on the first seat body 636 and formed with a threaded hole 638 permitting the corresponding driven rod 634 to extend therethrough. Each of the driven rods 634 has one end journalled on the plate body 611, and the other end having an externally threaded portion 639 engaging the threaded hole 638 in the corresponding mounting seats 633. Each of the second driving gears 635 meshes with a respective one of the first driving gears 632, so that rotation of the driving rod 631 can be transferred to the driven rods 634, thereby rotating and moving the driving rods 634 relative to the second seat bodies 637 of the mounting seats 633.

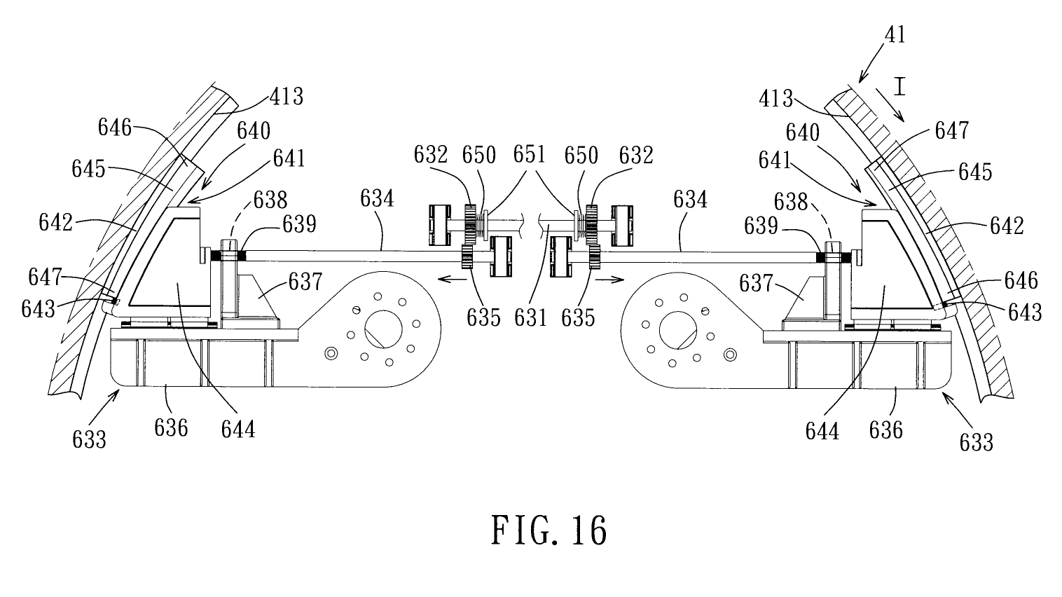

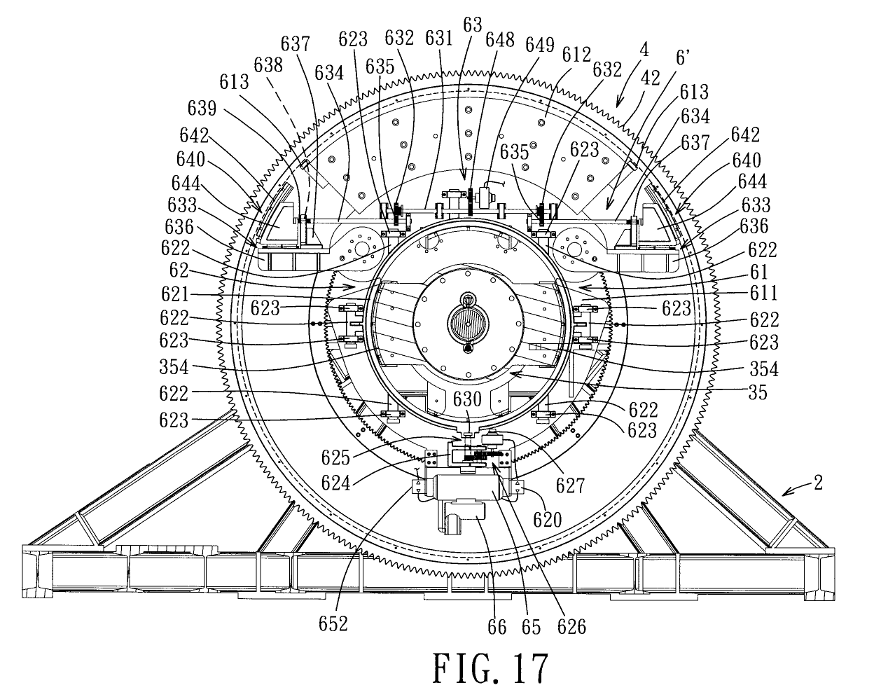

The outer clutch 63 further includes two braking members 640 disposed respectively on the first seat bodies 636 of the mounting seats 633. Each of the braking members 640 includes a sliding seat 641 connected movably on the corresponding first seat body 636, a brake plate 642 disposed on the sliding seat 641, and a spring 643. With further reference to FIG. 15, each of the sliding seats 641 includes a body 644 connected fixedly to the corresponding driven rod 634 (i.e., disposed movably on the corresponding first seat body 636) and formed with a dovetail groove 644′, and a sliding plate 645 mounted with the corresponding brake plate 642 and having a dovetail tongue 645′ disposed slidably within the dovetail groove 644′. The brake plates 642 are movable to press against a wall defining the first annular groove 413. Each of the dovetail grooves 644′ is defined by a bottom wall 644″ (see FIG. 15), which is spaced apart from the wall defining the first annular groove 413 by a distance reducing gradually in a counterclockwise direction. Each of the sliding plates 645 is tapered, and has a thicker first end 646, and a thinner second end 647 opposite to the first end 646. Each of the springs 643 is a coiled spring, and is connected between the sliding plate 645 and the body 644 of the corresponding sliding seat 641. With particular reference to FIG. 14, in this embodiment, each of the sliding plates 645 further has a tapered brake-mounting portion 645″ connected integrally to the dovetail tongue 645′, disposed outwardly of the body 644, and having a thickness reducing gradually from the thicker first end 646 to the thinner second end 647 in the counterclockwise direction. That is, the thickness of each of the sliding plates 645 is not uniform. The thickness difference of the first and second ends 646, 647 of each of the sliding plates 645 is smaller than 2 mm. As such, each of the springs 643 biases the corresponding sliding plate 645 to move in the counterclockwise direction relative to the corresponding body 644 such that the left spring 643 serves as a tension spring, and the right spring 643 serves as a compression spring.

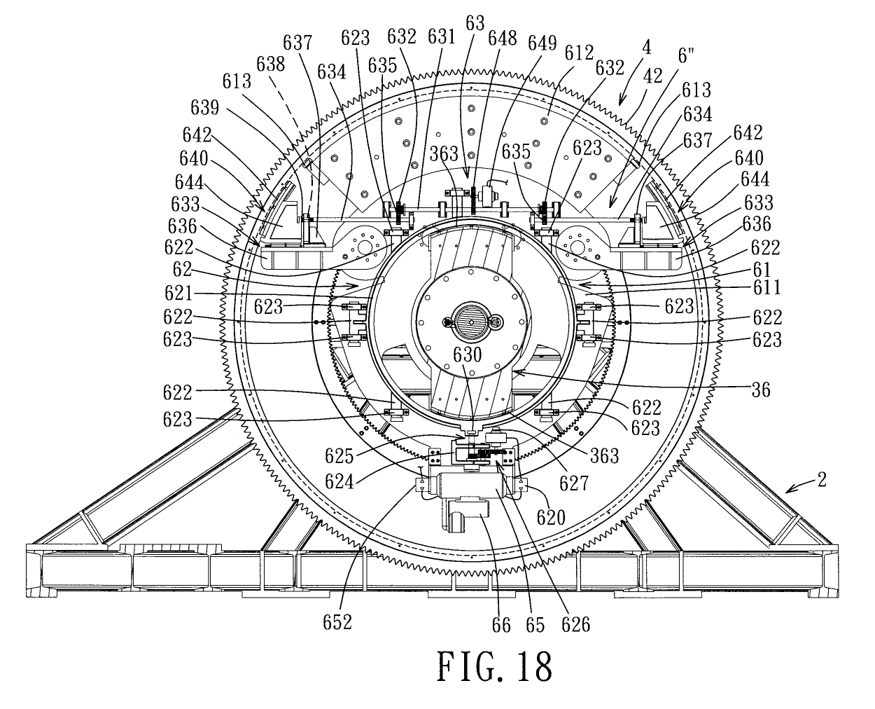

The outer clutch 63 further includes a second gear unit 648 and a second motor 649, as shown in FIG. 10. The second gear unit 648 is connected between the driving rod 631 and the second motor 649. The second motor 649 is a pneumatic motor, and is operable to activate the second gear unit 648 so as to rotate the driving rod 631, the first driving gears 632, the second driving gears 635, and the driven rods 634 in two directions, thereby moving the driven rods 634 toward or away from each other. Hence, each of the braking members 640 is movable between a braking position shown in FIG. 16 whereat the corresponding brake plate 642 presses against the wall defining the first annular groove 413, and a non-braking position shown in FIG. 14 whereat the corresponding brake plate 642 is removed from the wall defining the first annular groove 413. As such, the outer clutch 63 is convertible between a locking state shown in FIG. 16, and a release state shown in FIG. 14.

When the rotary wheel 41 of the rotating device 4 is rotated clockwise, and when the outer clutch 63 is converted into the locking state, the bodies 644 of the sliding seats 641 are moved away from each other to allow for frictional contact between the brake plates 642 and the wall defining the first annular groove 413. At this time, due to non-uniform thickness design of the sliding plates 645 and the presence of the springs 643, the brake plates 642 are biased to press against the wall defining the first annular groove 413. As such, the output of the second motor 649 can be reduced. It should be noted that, if the rotary wheel 41 is rotated counterclockwise, the thickness of each of the sliding plates 645 must reduce gradually in a clockwise direction. When the brake plates 642 are removed from the wall defining the first annular groove 413, each of the brake plates 642 and the sliding plates 645 is biased by the springs 643 to return to the position shown in FIG. 14.

It is noted that, wearing degree or speed of the brake plates 642 of the braking members 640 may be different. If this occurs, when one of the brake plates 642 comes into contact with the wall defining the first annular groove 413 so that the corresponding braking member 640 is moved to the braking position, the other of the brake plates 642 is spaced apart from the same. To solve this problem, in this embodiment, two torsion springs 650 are sleeved on the driving rod 631, and two positioning plates 651 are fixed to the driving rod 631, as shown in FIG. 14. Each of the torsion springs 650 has two ends fastened respectively to the corresponding positioning plate 651 and the corresponding first driving gear 632. As such, if the left brake plate 642 comes into contact with the wall defining the first annular groove 413, due to the presence of the right torsion spring 650, the right first driving gear 632 can rotate about the driving rod 631 to press the right brake plate 642 against the wall defining the first annular groove 413.

The first power gain device 6 further includes an air reservoir 65 (see FIG. 10) disposed on the plate body 611 and adjacent to the first motor 627, and an air pump 66 in fluid communication with the air reservoir 65 for forcing air into the air reservoir 65. A first electromagnetic valve 620 is disposed between the air reservoir 65 and the first motor 627, and is operable to allow or interrupt flow of air from the air reservoir 65 into the first motor 627 so as to control rotation of the output shaft of the first motor 627 in two directions. A second electromagnetic valve 652 is disposed between the air reservoir 65 and the second motor 649, and is operable to allow or interrupt flow of air from the air reservoir 65 into the second motor 649 so as to control rotation of an output shaft of the second motor 649 in two directions.

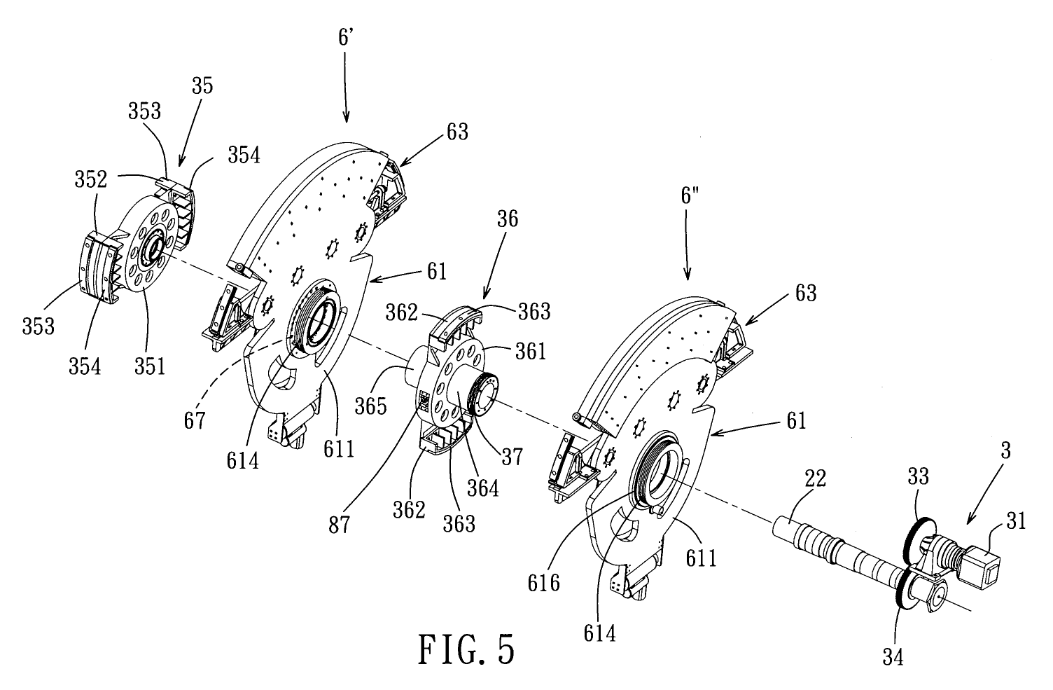

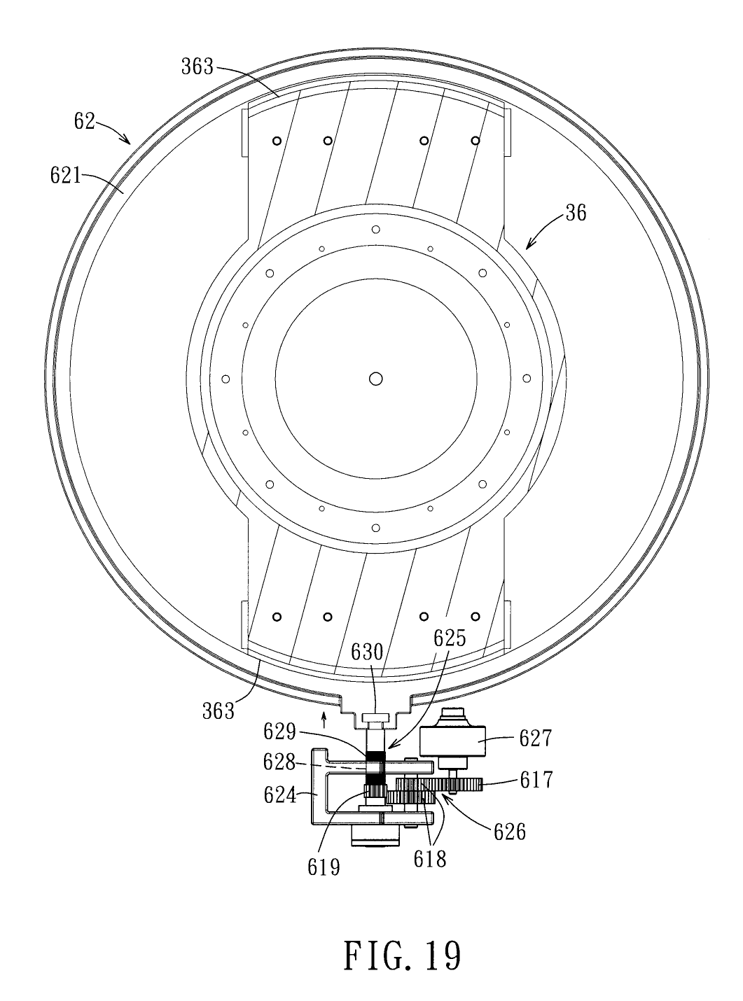

The second power gain device 6′ is disposed between the first and second transmission members 35, 36, as shown in FIG. 3. Referring to FIGS. 5, 6, 10, and 17, the second power gain device 6′ is similar in construction to the first power gain device 6 except for the following. The rotatable body 61 of the second power gain device 6′ is sleeved rotatably on the second tube body 365 of the second transmission member 36 such that a plurality of bearings 602 (see FIG. 6) are disposed therebetween. The sliding wheels 613 of the rotatable body 61 of the second power gain device 6′ are disposed movably within the second annular groove 414 in the rotary wheel 41. The rotatable body 61 of the second power gain device 6′ is provided with a plurality of first magnets 67 arranged along a circle. The brake ring 621 of the inner clutch 62 of the second power gain device 6′ can be pushed by the pushing member 625 of the second power gain device 6′ to press against or separate from the second brake shoes 354 of the first transmission member 35. The brake plates 642 of the outer clutch 63 of the second power gain device 6′ can be operated to press against or separate from a wall defining the second annular groove 414.

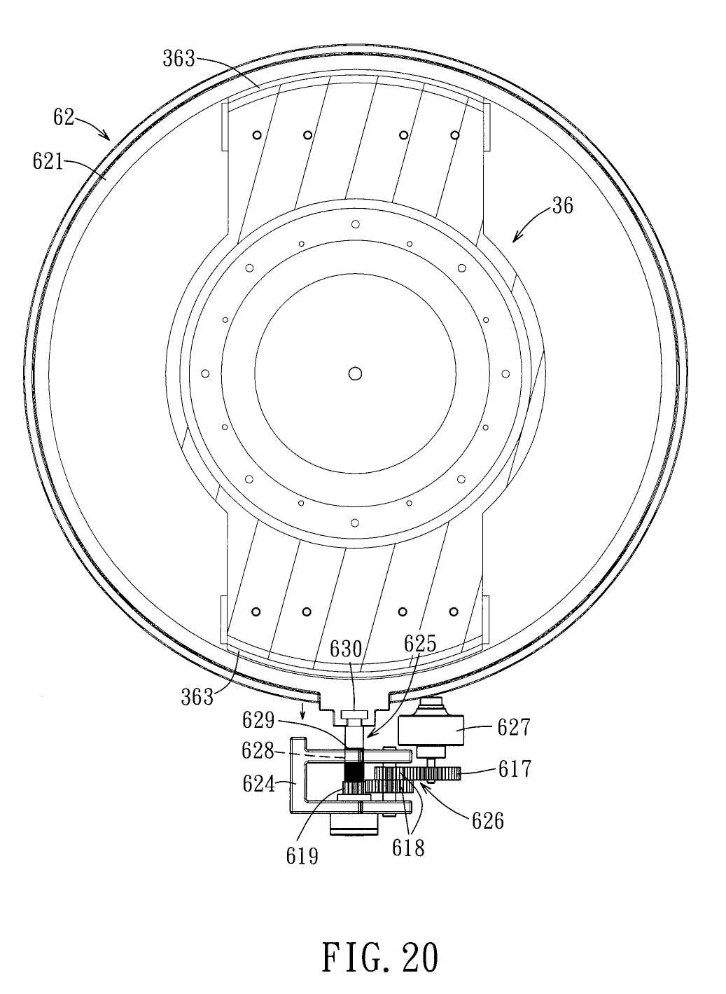

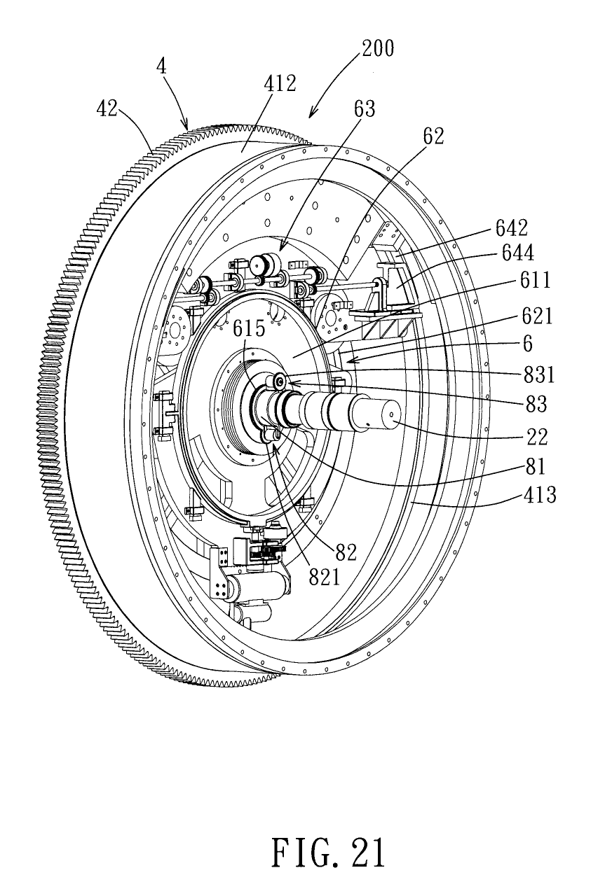

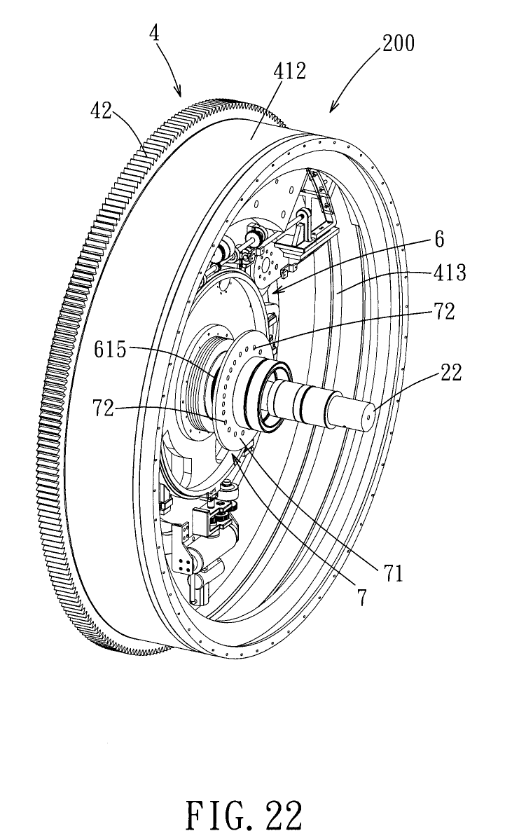

The third power gain device 6″ is disposed between the second transmission member 36 and the main driving gear 33, as shown in FIG. 3. Referring to FIGS. 5, 6, 10, and 18, the third power gain device 6″ is similar in construction to the first power gain device 6 except for the following. The rotatable body 61 of the second power gain device 6′ is sleeved rotatably on the first tube body 364 of the second transmission member 36 such that a plurality of bearings 603 is disposed therebetween. The sliding wheels 613 of the rotatable body 61 of the third power gain device 6″ are disposed movably within the third annular groove 415 in the rotary wheel 41. The brake ring 621 of the inner clutch 62 of the third power gain device 6″ can be moved by the pushing member 625 of the third power gain device 6″ to a first engagement portion shown in FIG. 19 and a second engagement position shown in FIG. 20. At the first engagement position, the brake ring 621 presses against the lower third brake shoe 363. At the second engagement position, the brake ring 621 presses against the upper third brake shoe 363. The brake plates 642 of the outer clutch 63 of the third power gain device 6″ can be operated to press against or separate from a wall defining the third annular groove 415.

Referring to FIGS. 3, 4, and 5, the rotary disk 7 includes a disk body 71 sleeved rotatably on the pivot shaft 22, and a plurality of second magnets 72 disposed on the disk body 71 and arranged along a circle. The second magnets 72 are aligned respectively with the first magnets 67 of the second power gain device 6′ so as to create a magnetic attractive force between the first and second magnets 67, 72, thereby allowing for co-rotation of the rotary disk 7 with the second power gain device 6′ . In this embodiment, the disk body 71 of the rotary disk 7 is made of a plastic steel material. Alternatively, the disk body 71 may be made of any other suitable light-weight metal.

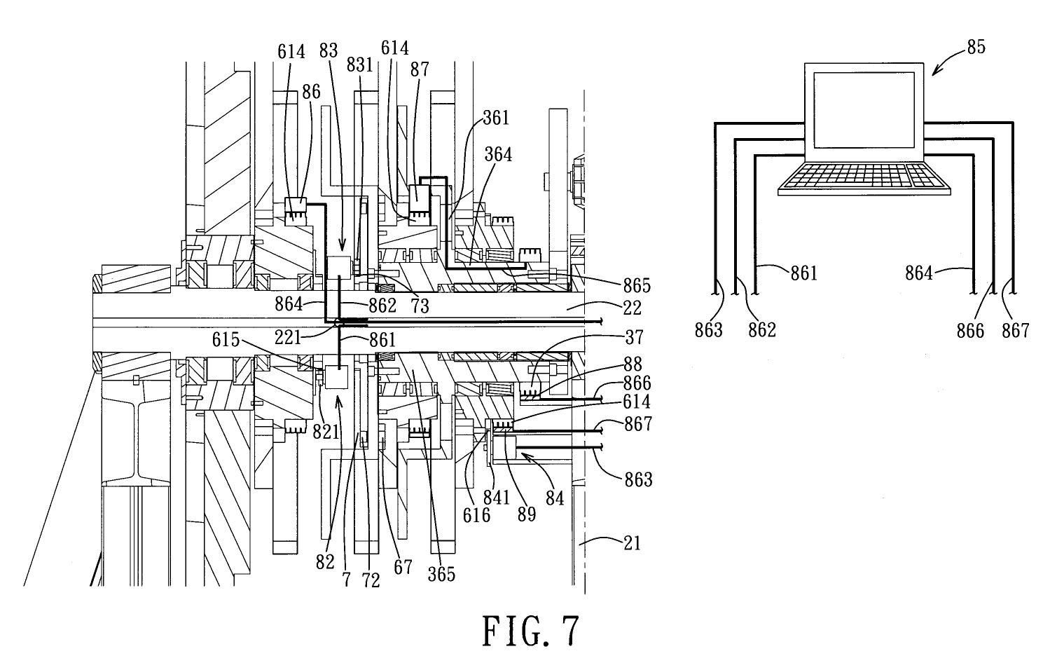

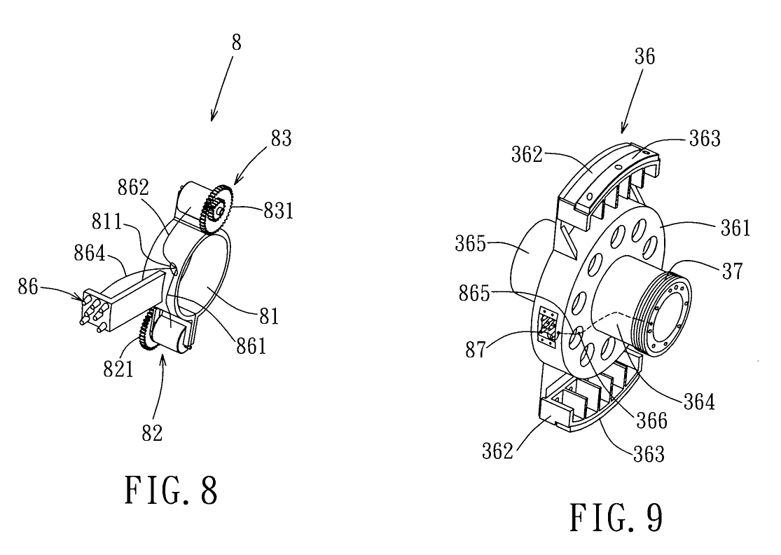

With further reference to FIGS. 7 and 8, the control device 8 includes a fixed ring 81 sleeved fixedly on the pivot shaft 22 and disposed between the first transmission member 35 and a first gear 615 on a front side surface of the plate body 611 of the first power gain device 6, a first detecting member 82 disposed on the fixed ring 81, a second detecting member 83 disposed on the fixed ring 81, a third detecting member 84 disposed on the front support frame 21, and a control unit 85. Each of the first, second, and third detecting members 82, 83, 84 is a code translator, and is provided with a coupling gear 821, 831, 841. The first transmission member 35 is disposed between the fixed ring 91 and the second power gain device 6′. The disk 7 is disposed between the fixed ring 81 and the first transmission member 35. The coupling gear 821 of the first detecting member 82 meshes with the first gear 615. The coupling gear 831 of the second detecting member 83 meshes with a second gear 73 on a rear side surface of the disk body 71 of the rotary disk 7. The coupling gear 841 of the third detecting member 84 meshes with a third gear 616 on a front side surface of the plate body 611 of the third power gain device 6″. The first, second, and third detecting members 82, 83, 84 are used to detect the rotational speeds and angles of the first, second, and third power gain devices 6, 6′, 6″, respectively, and emit positional signals to the control unit 85 via first, second, and third transmission lines 861, 862, 863, respectively. The first and second transmission lines 861, 862 extend through a guiding hole 221 in the pivot shaft 22 and a through hole 811 in the fixed ring 81. The first transmission line 961 electrically connects the first detecting member 82 to the control unit 85. The second transmission line 862 electrically connects the second detecting member 83 to the control unit 85. The control unit 85 is a computer, and can adjust the speed of the driving motor 31 according to the positional signals received thereby so as to control the rotational speeds of the first, second, and third power gain devices 6, 6′, 6″.

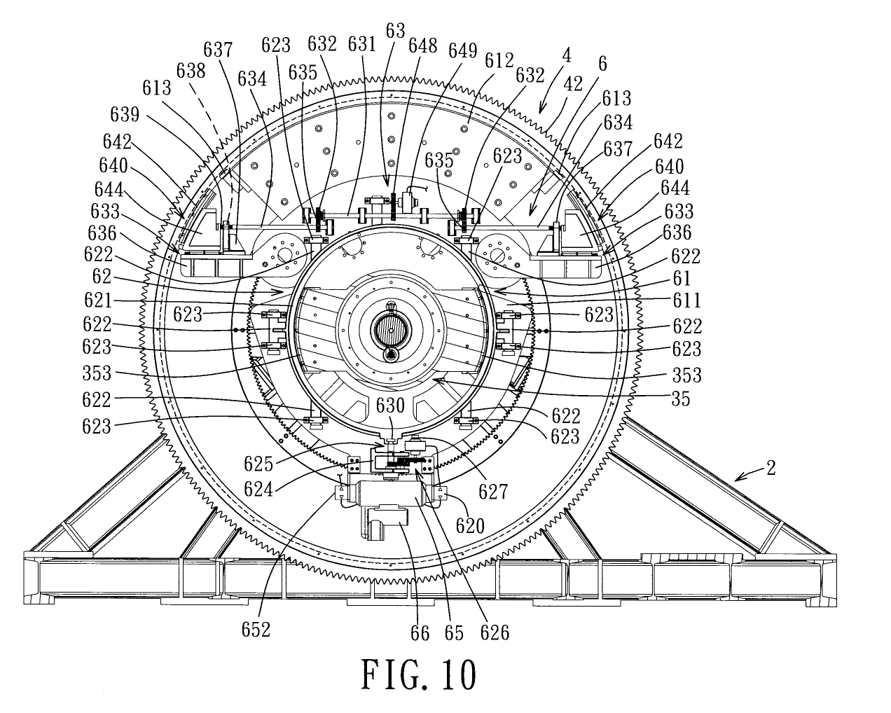

Referring to FIGS. 5, 7, 8, and 9, the control device 8 further includes a first conductive terminal unit 86 (see FIG. 3) disposed on the fixed ring 81, a second conductive terminal unit 87 (see FIG. 7) disposed on the sleeve 361 of the second transmission member 36, and a pair of third and fourth conductive terminal units 88, 89 (see FIG. 7). The first conductive terminal unit 86 is electrically connected to the control unit 85 by a first conductive wire 864, which extends through the guiding hole 221 in the pivot shaft 22 and the through hole 811 in the fixed ring 81. The first conductive terminal unit 86 is in contact with a carbon brush 614 disposed on a front side surface of the plate body 611 of the first power gain device 6. As such, electricity can be transmitted from the control unit 85 to the carbon brush 614 of the first power gain device 6 by the first conductive terminal unit 86. The second conductive terminal unit 87 is electrically connected to a conductive carbon brush 37 disposed on the first tube body 364 of the second transmission member 36 by a second conductive wire 865, which extends through a through hole 366 (see FIG. 9) in the second transmission member 36. The second conductive terminal unit 87 is in contact with a carbon brush 614 disposed on a front side surface of the plate body 611 of the second power gain device 6′ . The third conductive terminal unit 88 is in contact with the conductive carbon brush 37. The conductive carbon brush 37 is electrically connected to the control unit 85 by a third conductive wire 866. As such, electricity can be transmitted from the control unit 85 to the carbon brush 614 of the second power gain device 6′ via the conductive carbon brush 37 and the second conductive terminal unit 87. The fourth terminal unit 89 is electrically connected to the control unit 85 by a fourth conductive wire 867, and is in contact with a carbon brush 614 disposed on a front side surface of the plate body 611 of the third power gain device 6″. As such, electricity can be transmitted from the control unit 85 to the carbon brush 614 of the third power gain device 6″.

Since the first, second, and fourth conductive terminal units 86, 87, 89 are in contact with the carbon brushes 614 of the first, second, and third power gain devices 6, 6′, 6″, electricity can be transmitted from the carbon brushes 614 of the first, second, and third power gain devices 6, 6′, 6″ to the air pump 66 (see FIGS. 10, 17, and 18) and the first and second electromagnetic valves 620, 625 (see FIGS. 10, 17, and 18) by conductive wires (not shown). Hence, the control unit 85 can control the operation of the inner and outer clutches 62, 63 of the first, second, and third power gain devices 6, 6′, 6″.

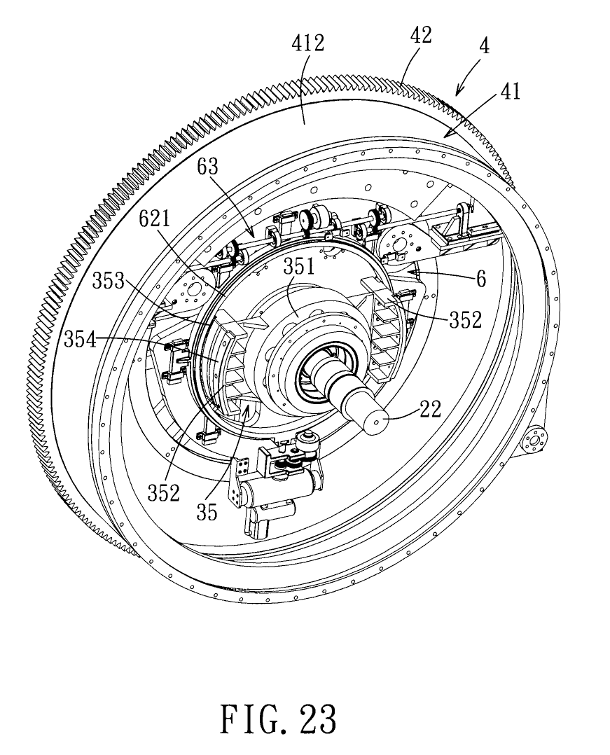

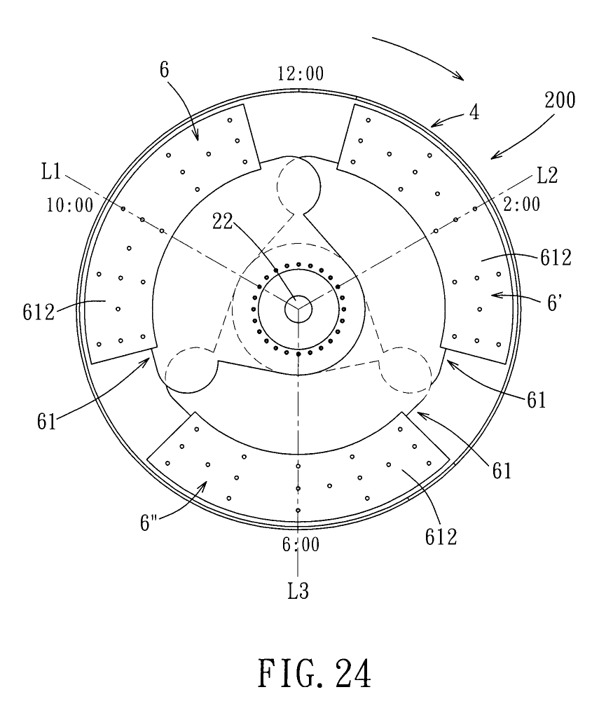

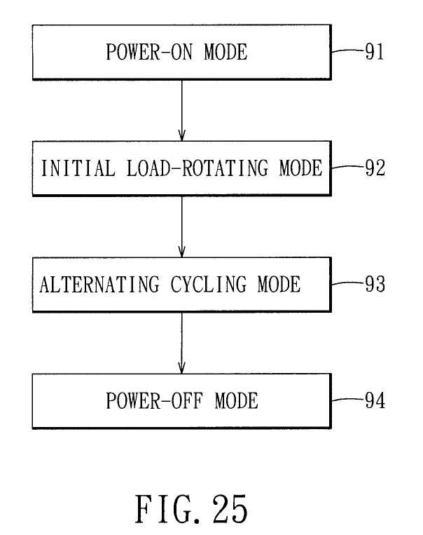

Referring to FIGS. 3, 21, 22, and 23, during assembly of the rotating type power gain machine 200, the first power gain device 6 is first mounted to the pivot shaft 22. Next, the fixed ring 81, the rotary disk 7, the first transmission member 35, the second power gain device 6′, the second transmission member 36, and the third power gain device 6″ are mounted in turn to the pivot shaft 22. In this embodiment, the first transmission member 35 is located between the second detecting member 83 disposed on the fixed ring 81 and the second power gain device 6′, so that the second power gain device 6′ cannot contact directly the coupling gear 831 of the second detecting member 83. To enable the second detecting member 83 to detect the rotational speed and angle of the second power gain device 6′, the rotary disk 7 is provided to co-rotate with the second power gain device 6′ due to the magnetic attractive force generated between the first and second magnets 67, 72, and the coupling gear 831 of the second detecting member 83 meshes with the second gear 73 of the rotary disk 7. The sleeve 351 and the wings 352 of the first transmission member 35 are made of stainless steel that is weak in magnetic conductivity. Since the disk body 71 of the rotary disk 7 is made of the lightweight plastic steel material, as described above, the magnetic attractive force required for co-rotation of the second power gain device 6′ and the rotary disk 7 can be reduced significantly.

The operation of the rotating type power gain machine 200 will be described hereinafter.

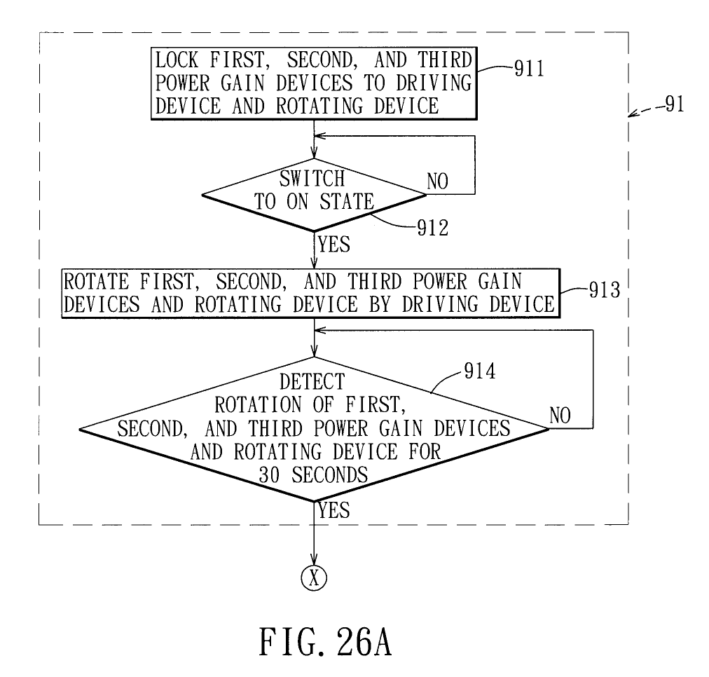

Referring to FIGS. 24, 25, and 26A, each of the first, second, and third power gain devices 6, 6′, 6″ has a central line (L1, L2, L3) extending radially through the center of the counterweight portion 612 of the rotatable body 61 thereof and the center of the pivot shaft 22.

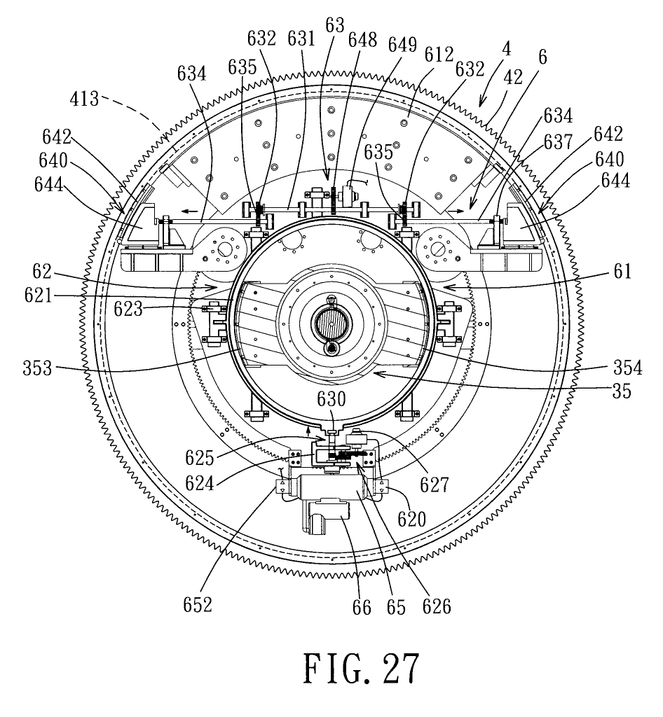

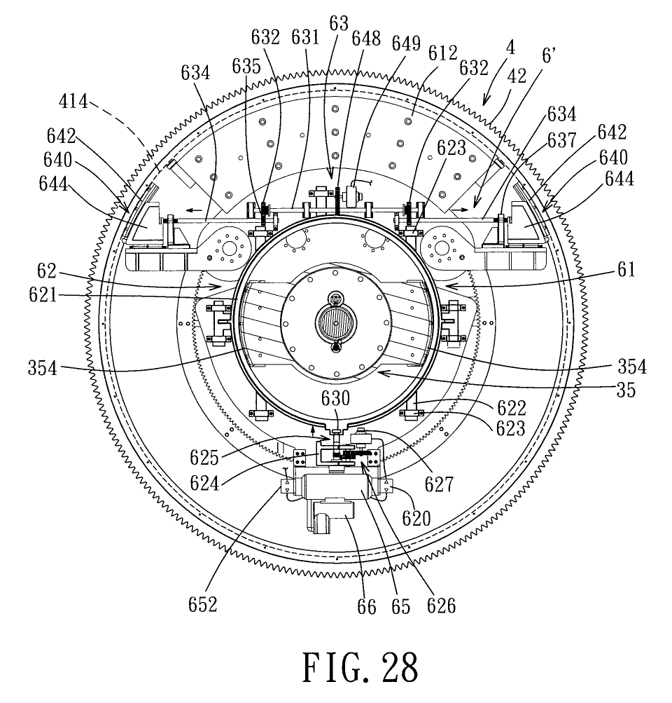

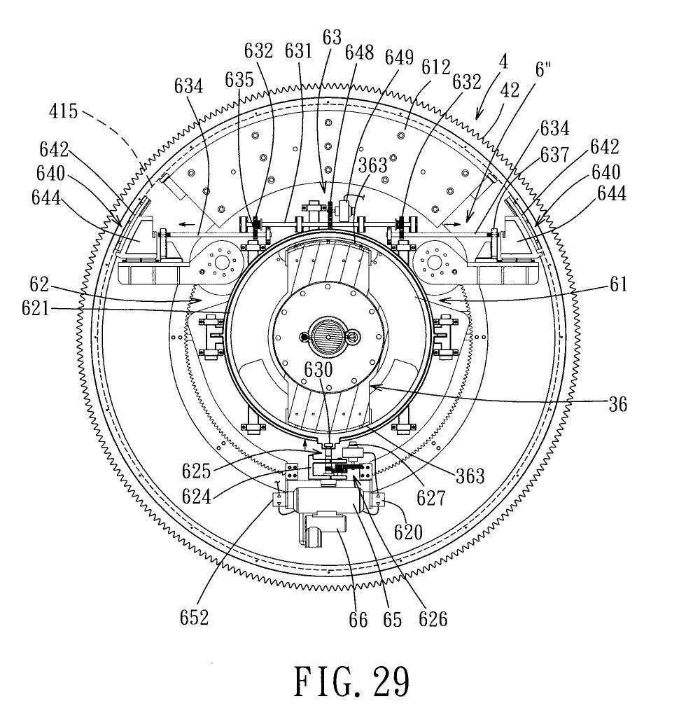

During a power-on mode 91, in step 911, when the rotating type power gain machine 200 is not operated, the inner clutches 62 of the first and second power gain devices 6, 6′ are locked to the first transmission member 35, the inner clutch 62 of the third power gain device 6″ is locked to the second transmission member 36, and the outer clutches 63 of the first, second, and third power gain devices 6, 6′, 6″ are locked respectively within the first, second, and third annular grooves 413, 414, 415, as shown in FIGS. 27, 28, and 29. In this state, any adjacent pair of the first, second, and third power gain devices 6, 6′, 6″ are spaced apart from each other by an angle of 120°. That is, any adjacent pair of the central lines (L1, L2, L3) of the first, second, and third power gain devices 6, 6′, 6″ are spaced apart from each other by an angle of 120°, as shown in FIG. 24. As such, the first, second, and third power gain devices 6, 6′, 6″ are in a balance state. For convenience of illustration, the positions of the first, second, and third power gain devices 6, 6′, 6″ will be represented respectively by those of the central lines (L1, L2, L3) hereinafter.

In step 912, the rotating type power gain device 200 is switched to an on state so as to start the operation of the rotating type power gain device 200. Hence, instep 913, the driving motor 31 rotates clockwise the first, second, and third power gain devices 6, 6′, 6″ and the rotating device 4 at a preset speed ranging from 3.5 to 5.5 rpm. In this embodiment, the first, second, and third power gain devices 6, 6′, 6″ and the rotating device 4 are rotated at a speed of 3.5 rpm.

In step 914, when detecting by the first, second, and third detecting members 82, 83, 84 that the first, second, and third power gain devices 6, 6′, 6″ rotate from their starting positions for a preset time period, the rotating type power gain machine 200 is switched automatically to an initial load-rotating mode 92. In this embodiment, the preset time period is 30 seconds. Alternatively, the power-on mode 91 may be switched to the initial load-rotating mode 92 through a manual operation.

During the initial load-rotating mode 92, at any time, two of the first, second, and third power gain devices 6, 6′, 6″ are locked to the rotating device 4 and unlocked from the driving device 3, and the remaining one of the first, second, and third power gain devices 6, 6′, 6″ is locked to the driving device 3 and unlocked from the rotating device 4. For convenience of illustration, the two of the first, second, and third power gain devices 6, 6′, 6″ are exemplified by the first and second power gain devices 6, 6′. Referring to FIGS. 7, 26A and 30, in step 921, when the first detecting member 82 detects that the central line (L1) of the first power gain device 6 rotates clockwise to a first angular position, it emits a positional signal to the control unit 85. Hence, step 922 is performed under control of the control unit 85, and includes unlocking the inner clutches 62 of the first and second power gain devices 6, 6′ from the first transmission member 35 (see FIG. 10), and simultaneously unlocking the outer clutch 63 of the third power gain device 6″ from the wall of the rotary wheel 41 defining the third annular groove 415. Since the first and second power gain devices 6, 6′ are subjected to inertial forces for 30 seconds, after the inner clutches 62 of the first and second power gain devices 6, 6′ are unlocked from the first transmission member 35, the first and second power gain devices 6, 6′ can rotate the rotating device 4 by virtue of gravity due to the fact that the former is still locked to the latter. Hence, gained power can be transmitted from the rotating device 4 to the generator. During downward rotation of the central lines (L1, L2) of the first and second power gain devices 6, 6′ from the first angular position, the rotational speed of the first and second power gain devices 6, 6′ is reduced to about 1 rpm. In this embodiment, the first angular position is 12:30 o'clock position, i.e., at an upper end portion of the rotating device 4, but not limited thereto. Any angular position allowing each of the first, second, and third power gain devices 6, 6′, 6″ to have a tendency to rotate downwardly by virtue of its gravity can serve as the first angular position.

When the central line (L1) of the first power gain device 6 is at the first angular position (i.e., 12:30 o'clock position), the central line (L2) of the second power gain device 6′ is at an exchanging position, and the central line (L3) of the third power gain device 6″ is at 8:30 o'clock position. Preferably, the exchanging position of each of the central lines (L2, L3) of the second and third power gain devices 6′, 6″is located between 4:30 o'clock position and 5:00 o'clock position. In the power-on mode, the exchanging position of each of the central lines (L1, L2, L3) of the first, second, and third power gain devices 6, 6′, 6″ is 4:30 o'clock position.

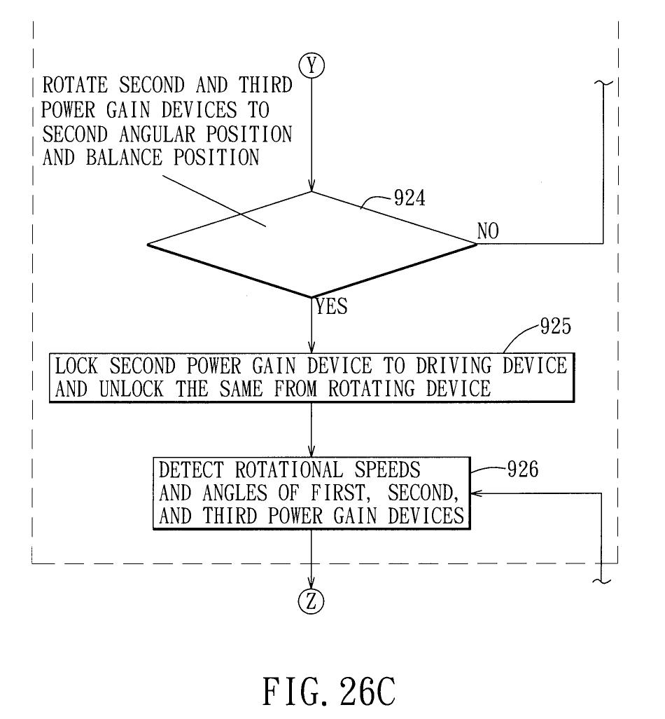

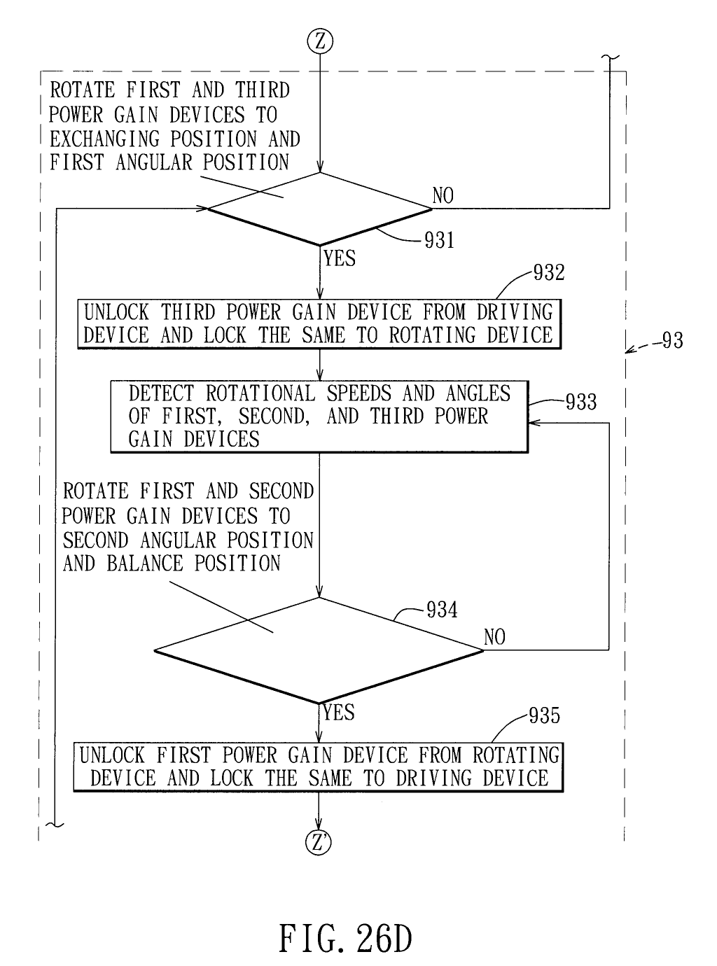

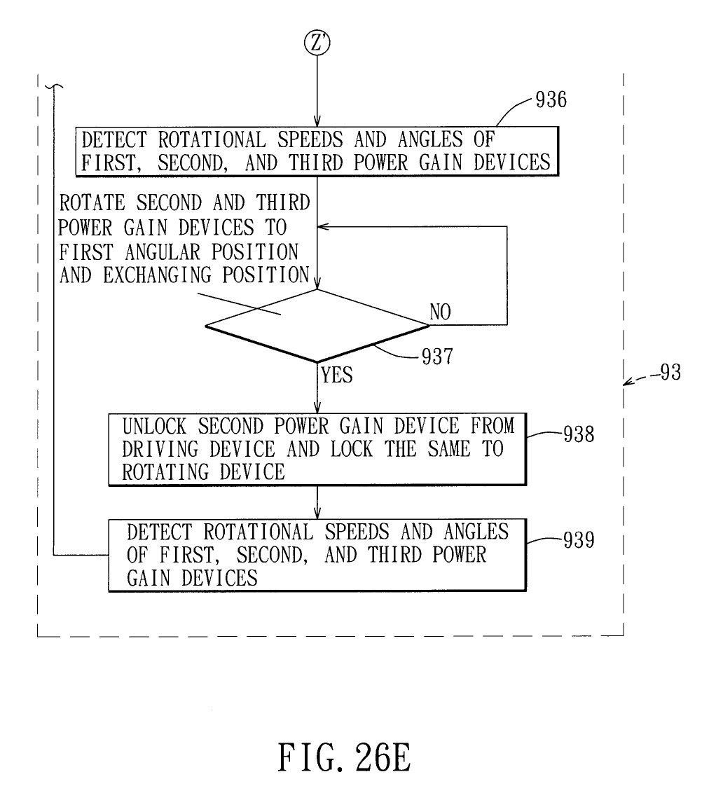

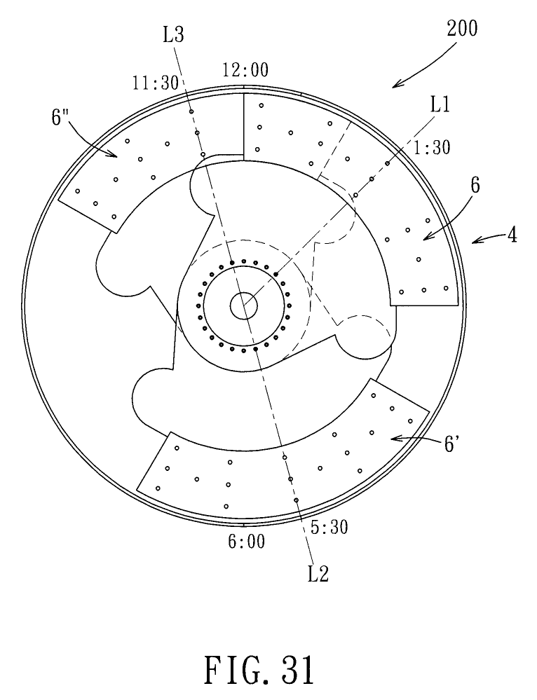

With further reference to FIGS. 26B and 31, in step 923, the first, second, and third detecting members 82, 83, 84 detect the rotational speeds and angles of the first, second, and third power gain devices 6, 6′, 6″ to thereby emit corresponding positional signals to the control unit 85. Hence, the control unit 85 adjusts the speed of the driving motor 31 to facilitate subsequent control of the control unit 85 to conversion of the inner and outer clutches 62, 63 of each of the first, second, and third power gain devices 6, 6′ , 6″ between the locking state and the release state.

In step 924, with particular reference to FIG. 31, when the central line (L3) of the third power gain device 6″ rotates to a balance position, the central line (L2) of the second power gain device 6′ is moved to a second angular position to align with the central line (L3) of the third power gain device 6″ so as to maintain a balance state between the second and third power gain devices 6′, 6″. Preferably, the balance position is located between 11:30 o' clock position and 12:00 o' clock position, and the second angular position is located between 5:00 o' clock position and 6:00 o' clock position. In this embodiment, the balance position is 11:30 o' clock position, and the second angular position is 5:30 o' clock position. In step 925, when the central line (L2) of the second power gain device 6′ is rotated to the second angular position, the control unit 85 locks the inner clutch 62 of the second power gain device 6′ to the first transmission member 35, and unlocks the outer clutch 63 of the second power gain device 6′ from the wall of the rotary wheel 41 defining the second annular groove 414, while the states of the first and third power gain devices 6, 6″ with respect to the driving device 3 and the rotating device 4 remain unchanged. Subsequently, the second and third power gain devices 6′, 6″ are controlled to rotate a preset number of revolutions for providing a large inertial force.

With further reference to FIGS. 26B, 26C, 32, and 33, in step 926, just before the central line (L1) of the first power gain device 6 is rotated to the exchanging position, the first detecting member 82 emits positional signals to the control unit 85. In the initial load-rotating mode, the exchanging position of each of the central lines (L1, L2, L3) of the first, second, and third power gain devices 6, 6′ , 6″ is 5:00 o' clock position, which is different from that in the power-on mode. Through operation of the second and third detecting members 83, 84, an angular interval between the first angular position and each of the central lines (L2, L3) of the second and third power gain devices 6′, 6″ can be realized. The control unit 85 adjusts the speed of the driving motor 31 according to the angular interval, and controls the rotating type power gain machine 200 into an alternating cycling mode 93.

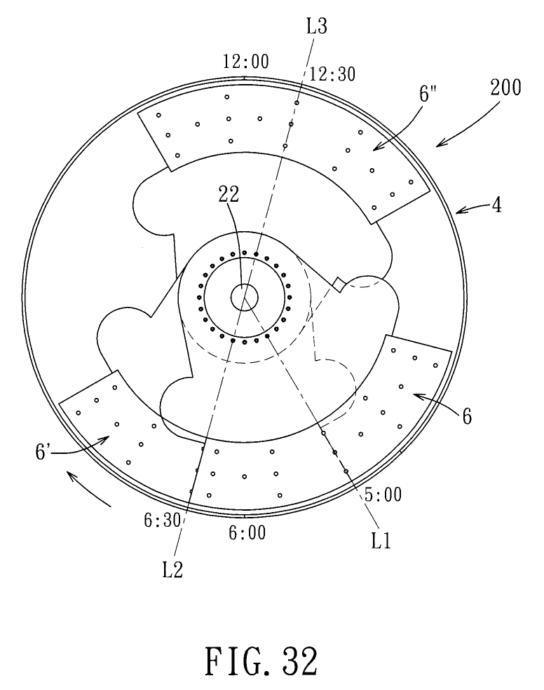

During the alternating cycling mode 93, in step 931, with particular reference to FIG. 32, when the central line (L1) of the first power gain device 6 reaches the exchanging position (i.e. 5:00 o' clock position) , the central line (L3) of the third power gain device 6″ is moved to the first angular position (i.e., 12:30 o' clock position) . In step 932, the control unit 85 unlocks the inner clutch 62 of the third power gain device 6″ from the second transmission member 36, and locks the outer clutch 63 of the third power gain device 6″ to the wall defining the third annular groove 415, while the states of the first and second power gain devices 6, 6′ with respect to the driving device 3 and the rotating device 4 remain unchanged. Hence, the third power gain device 6″ co-rotates with the rotating device 4 until the central line (L3) of the third power gain device 6″ reaches the second angular position. As a result, power can be outputted due to the co-rotation of the third power gain device 6″ with the rotating device 4. As described above, when the central line (L1) of the first power gain device 6 reaches the exchanging position (i.e., 5:00 o'clock position) , the central line (L3) of the third power gain device 6″ is moved to the first angular position so as to change the inner clutch 62 of the third power gain device 6″ from the locking state to the release state and so as to change the outer clutch 63 of the third power gain device 6″ from the release state to the locking state. That is, the states of the inner and outer clutches 62, 63 of the third power gain device 6″ are exchanged. In the alternating cycling mode 93, the exchanging position is 5:00 o'clock position, the second angular position is 6:00 o' clock position, and the balance position is 12:00 o'clock position. As such, the exchanging position is spaced apart from the second angular position by an angle of 30°.

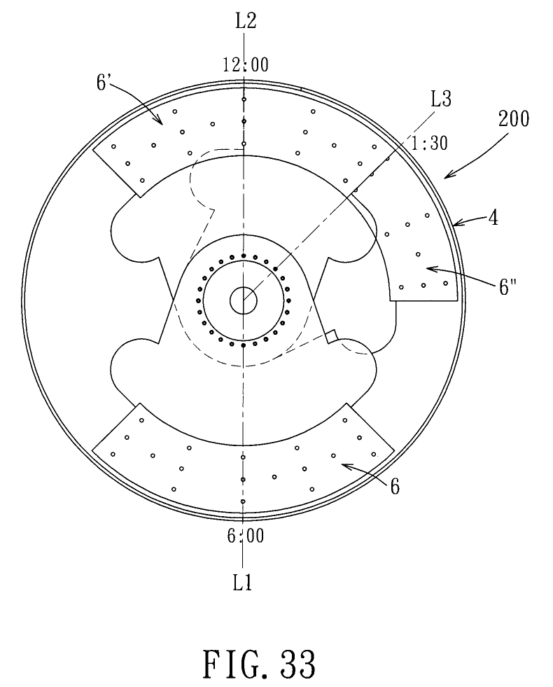

In step 933, the first, second, and third detecting members 82, 83, 84 detect the rotational speeds and angles of the first, second, and third power gain devices 6, 6′, 6″ to thereby emit corresponding positional signals to the control unit 85. Hence, the control unit 85 adjusts the speed of the driving motor 31 to facilitate subsequent control of the control unit 85 to conversion of the inner and outer clutches 62, 63 of the first power gain device 6 between the locking state and the release state. In step 934, with particular reference to FIG. 33, when the central line (L2) of the second power gain device 6′ reaches the balance position (i.e., 12:00 o' clock position), the central line (L1) of the first power gain device 6 is rotated to the second angular position (i.e., 6:00 o' clock position) to thereby align with the central line (L2) of the second power gain device 6′ , thus resulting in a balance state between the first and second power gain devices 6, 6′ . At this time, the control unit 85 locks the inner clutch 62 of the first power gain device 6 to the first transmission member 35, and unlocks the outer clutch 63 of the first power gain device 6 from the wall defining the first annular groove 413 (step 935) , while the states of the second and third power gain devices 6′, 6″ with respect to the driving device 3 and the rotating device 4 remain unchanged. Subsequently, the first and second power gain devices 6, 6′ are controlled to rotate a preset number of revolutions for providing a large inertial force (936).

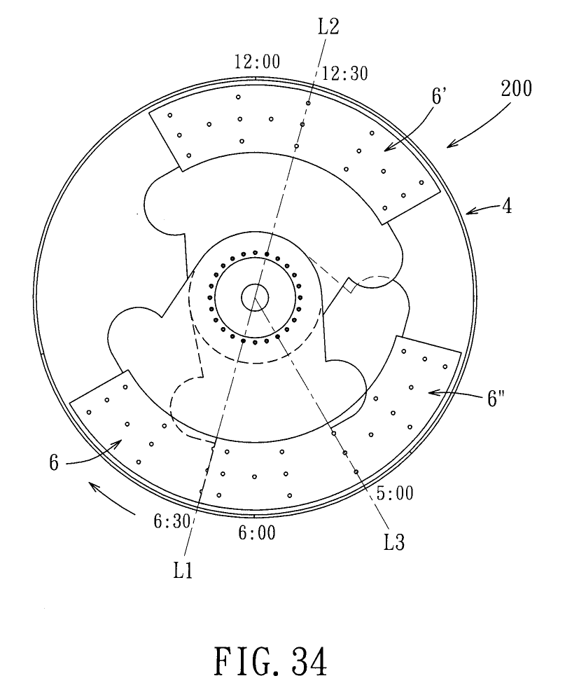

With particular reference to FIG. 26D and 34, in step 937, when the central line (L3) of the third power gain device 6″ reaches the exchanging position (i.e., 5:00 o' clock position) , the central line (L2) of the second power gain device 6′ is rotated to the first angular position (i.e., 12:30 o'clock position). At this time, the control unit 85 unlocks the inner clutch 62 of the second power gain device 6′ from the first transmission member 35, and locks the outer clutch 63 of the second power gain device 6′ to the wall defining the second annular groove 414 (step 938), while the states of the first and third power gain devices 6, 6″ with respect to the driving device 3 and the rotating device 4 remain unchanged. Hence, the second power gain device 6′ co-rotates with the rotating device 4 until the central line (L2) of the second power gain device 6′ reaches the second angular position. As a result, power can be outputted due to the co-rotation of the second power gain device 6″ with the rotating device 4.

In step 939, the first, second, and third detecting members 82, 83, 84 detect the rotational speeds and angles of the first, second, and third power gain devices 6, 6′, 6″ to thereby emit corresponding positional signals to the control unit 85. Hence, the control unit 85 adjusts the speed of the driving motor 31 to facilitate subsequent control of the control unit 85 to conversion of the inner and outer clutches 62, 63 of the first power gain device 6 between the locking state and the release state.

As such, at any time in the alternating cycling mode 93, each of the first, second, and third power gain devices 6, 6′, 6″ is locked to one of the driving device 3 and the rotating device 4, and is unlocked from the other of the driving device 3 and the rotating device 4. Also at any time in the alternating cycling mode, at least one of the first, second, and third power gain devices 6, 6′, 6″ is locked to the driving device 3, and at least one of the first, second, and third power gain devices 6, 6′, 6″ is locked to the rotating device 4 to thereby allow a high torque to be outputted continuously from the rotating device 4.

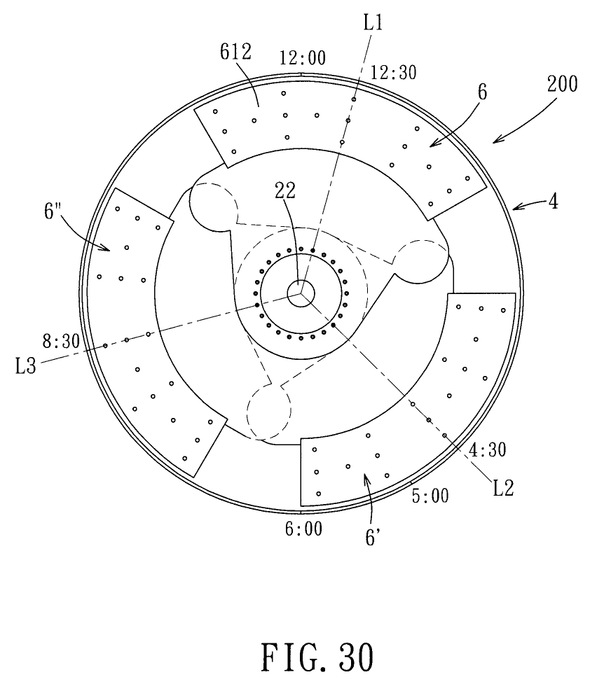

When one of the central lines (L1, L2, L3) of the first, second, and third power gain devices 6, 6′, 6″ is in the exchanging position such that the corresponding one of the first, second, and third power gain devices 6, 6′, 6″ is unlocked from the driving device 3, one of the remaining two of the central lines (L1, L2, L3) of the first, second, and third power gain devices 6, 6′, 6″ is at the first angular position, as shown in FIGS. 30, 32, 34, and is also unlocked from the driving device 3, thereby allowing continuous rotation of the rotating device 4 during the alternating cycling mode 93. When the one of the central lines (L1, L2, L3) of the first, second, and third power gain devices 6, 6′, 6″ is rotated from the exchanging position to the second angular position, one of the remaining two of the central lines (L1, L2, L3) of the first, second, and third power gain devices 6, 6′, 6″ is rotated to the balance position to thereby align with the one of the central lines (L1, L2, L3) of the first, second, and third power gain devices 6, 6′, 6″, as shown in FIGS. 31 and 33. Subsequently, the one of the central lines (L1, L2, L3) of the first, second, and third power gain devices 6, 6′, 6″ and the one of the remaining two of the central lines (L1, L2, L3) of the first, second, and third power gain devices 6, 6′, 6″ are rotated a predetermined number of revolutions by the driving device 3 in a balance state, thereby increasing the service life of the rotating type power gain machine 200.

Therefore, each of the first, second and third power gain devices 6, 6′, 6″ can be driven by the driving device 3 to rotate for a predetermined number of revolutions to thereby provide an inertial force. Furthermore, when each of the central lines (L1, L2, L3) of the first, second and third power gain devices 6, 6′, 6″ co-rotates with the rotating device 4 from the first angular position to the second angular position, the gravitational potential energy of a corresponding one of the first, second and third power gain devices 6, 6′, 6″ can be converted into kinetic energy, which cooperates with the inertial force to drive rotation of the rotating device 4. As a result, a power output can be gained during co-rotation of the rotating device 4 with the corresponding one of the first, second and third power gain devices 6, 6′, 6″.

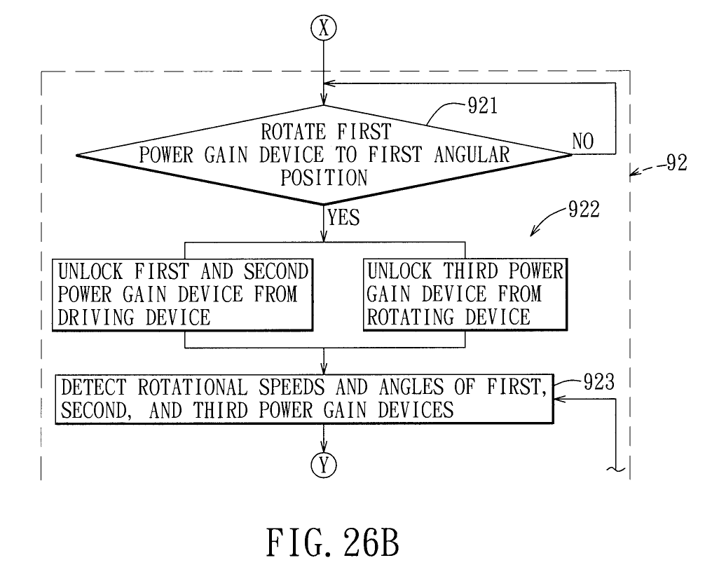

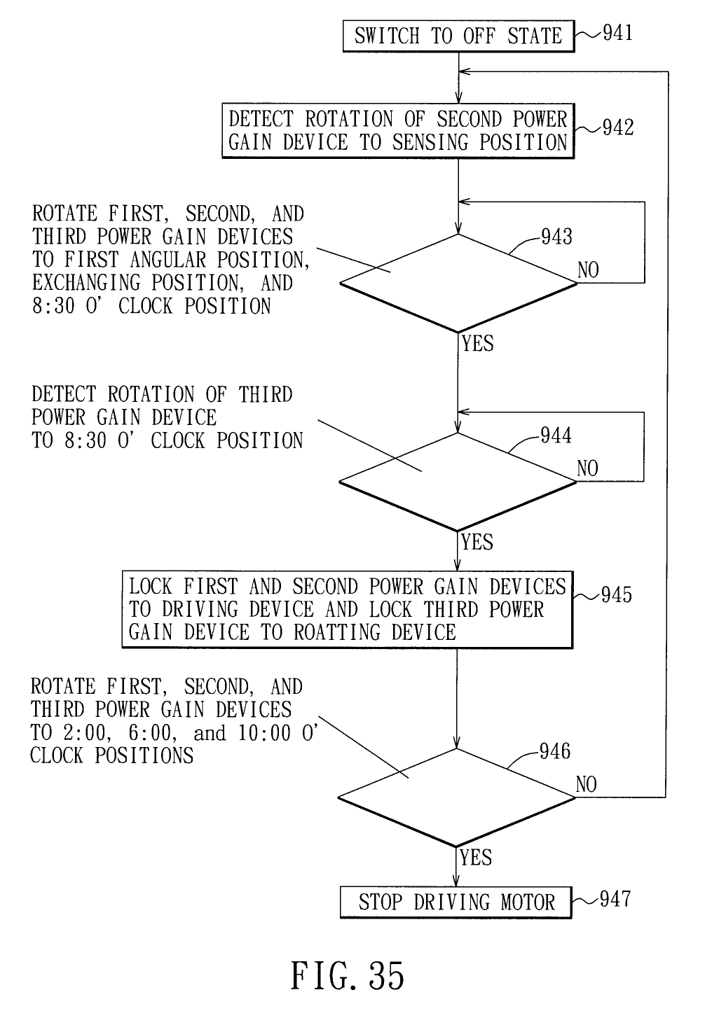

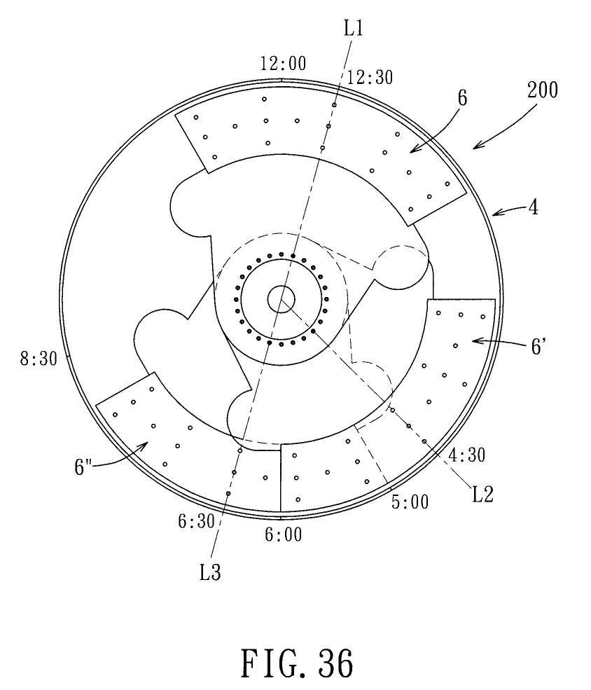

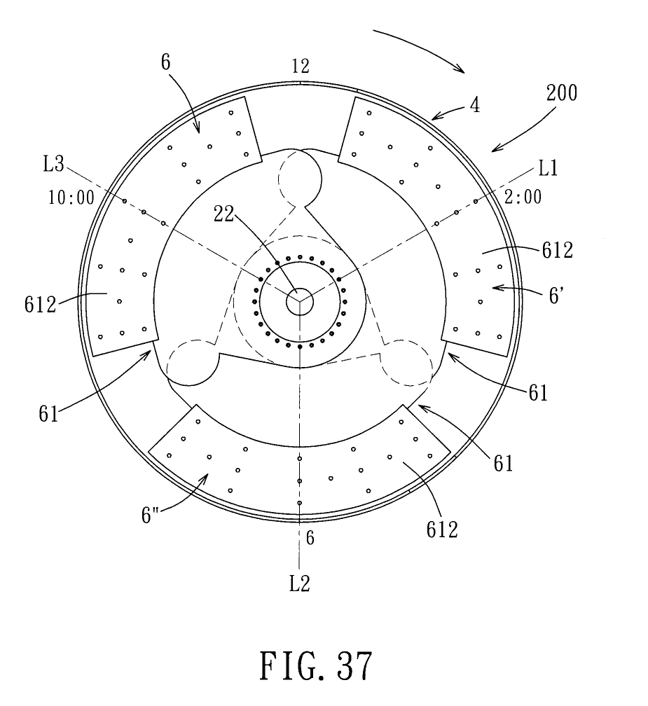

Referring to FIGS. 25, 35, and 36, during a power-off mode 94, in step 941, when the rotating type power gain machine 200 is switched to an off state, a power-off signal is transmitted to the control unit 85. Subsequently, in step 942, when detecting that the central line (L1, L2, L3) of one of the first, second, and third power gain devices 6, 6′, 6″ unlocked from the driving device 3 (exemplified using the second power gain device 6′) is rotated to a sensing position (i.e., 3:30 o' clock position) , the second detecting member 83 emits a positional signal to the control unit 85. Hence, the control unit 85 adjusts the speed of the driving motor 31 such that, in step 943, when the central line (L2) of the second power gain device 6′ reaches the exchanging position (i.e., 4:30 o' clock position), the central line (L1) of the first power gain device 6 is rotated to the first angular position (i.e., 12:30 o' clock position) , and the central line (L3) of the third power gain device 6″ is rotated to 8:30 o' clock position, as shown in FIG. 30. In step 944, when detecting that the central line (L3) of the third power gain device 6″ reaches 8:30 o' clock position, the third detecting member 84 emits a positional signal to the control unit 85. Hence, in step 945, the control unit 85 locks the first and second power gain devices 6, 6′ to the driving device 3, and locks the third power gain device 6″ to the rotating device 4 so that each of the first, second, and third power gain devices 6, 6′, 6″ is locked to both the driving device 3 and the rotating device 4, thereby allowing for co-rotation of the first, second, and third power gain devices 6, 6′ , 6″ with the driving device 3 and the rotating device 4. In step 946, when the rotating device 4 is rotated by an angle of 45° to move the central lines (L1, L2, L3) of the first, second, and third power gain devices 6, 6′, 6″ to 2:00, 6:00, and 10:00 o'clock positions, respectively, as shown in FIG. 37, the driving motor 31 is stopped (step 947).

It should be noted that, the number of the power gain devices 6, 6′, 6″ can be changed. However, when the number of the power gain devices 6, 6′, 6″ is reduced, the efficiency of the rotating type power gain machine 200 is poor, and when the number of the power gain devices 6, 6′, 6″ is increased, the design of the rotating type power gain machine 200 is complex.

For example, the rotating type power gain machine 200 may include only two power gain devices. If this occurs, in the alternating cycling mode, when one of the two power gain devices rotates from the exchanging position to the second angular position, the two power gain devices are unlocked from the driving device 3 and locked to the rotating device 4 (i.e., neither of the two power gain devices is locked to the driving device 3).

With this invention thus explained, it is apparent that numerous modifications and variations can be made without departing from the scope and spirit of this invention. It is therefore intended that this invention be limited only as indicated by the appended claims.

1. A power gain machine comprising:
a base;
a driving device disposed on said base;
a rotating device disposed rotatably on said base;
first, second, and third power gain devices disposed rotatably on said base and locked releasably on said driving device and said rotating device such that, each of said first, second, and third power gain devices is driven to rotate by said driving device relative to said base when locked to said driving device; and
a control device for controlling operation of said first, second, and third power gain devices in an alternating cycling mode such that: each of said first, second, and third power gain devices is locked to one of said driving device and said rotating device and is unlocked from the other of said driving device and said rotating device at any time during the alternating cycling mode; at least one of said first, second, and third power gain devices is locked to said driving device, and at least one of said first, second, and third power gain devices is locked to said rotating device at any time during the alternating cycling mode; said first, second, and third power gain devices are alternately unlocked from said driving device at a first angular position at different times so that each of said first, second, and third power gain devices can rotate downwardly from said first angular position to a second angular position disposed below said first angular position by gravity when locked to said rotating device; said first, second, and third power gain devices are alternately locked to said driving device at the second angular position at different times; and just before one of said first, second, and third power gain devices locked to said rotating device is rotated to said second angular position, one of the remaining two of said first, second, and third power gain devices is rotated to said first angular position.

2. The power gain machine as claimed in claim 1, wherein said first angular position is disposed at an upper end portion of said rotating device.

3. The power gain machine as claimed in claim 1, wherein said control device further controls the operation of said first, second, and third power gain devices such that, when one of said first, second, and third power gain devices reaches said second angular position, one of the remaining two of said first, second, and third power gain devices is rotated to a balance position diametrically opposite to said second angular position so as to maintain a balance state therebetween, and said one of said first, second, and third power gain devices is unlocked from said rotating device and locked to said driving device.

4. The power gain machine as claimed in claim 1, wherein said control device further controls the operation of said first, second, and third power gain devices such that, when one of said first, second, and third power gain devices locked to said rotating device is rotated to an exchanging position spaced apart from said second angular position by an angle of 30°, the one of the remaining two of said first, second, and third power gain devices is rotated to said first angular position.

5. The power gain machine as claimed in claim 1, wherein said control device includes first, second, and third detecting members each disposed for detecting the rotational speed and angle of a respective one of said first, second, and third power gain devices to thereby emit a signal therefrom, and a control unit electrically connected to said first, second, and third detecting members so as to receive the signal, thus controlling said driving device to adjust the rotational speed of at least one of said first, second, and third power gain devices.

6. The power gain machine as claimed in claim 5, wherein each of said detecting members is a code translator.

7. The power gain machine as claimed in claim 1, wherein said base includes a pivot shaft, each of said first, second, and third power gain devices being sleeved rotatably on said pivot shaft, and including an inner clutch locked releasably on said driving device.

8. The power gain machine as claimed in claim 7, wherein:
said second power gain device is disposed between and spaced apart from said first and third power gain devices along an axial direction of said pivot shaft;
said driving device includes a first transmission member sleeved rotatably on said pivot shaft and disposed between said first and second power gain devices, and a second transmission member sleeved rotatably on said pivot shaft and disposed between said second and third power gain devices; and
said control device includes a control unit for controlling said inner clutch of each of said first, second, and third power gain devices to convert between a locking state and a release state, said inner clutch of each of said first and second power gain devices being locked to said first transmission member when in the locking state, and unlocked from said first transmission member when in the release state, said inner clutch of said third power gain device being locked to said second transmission member when in the locking state, and unlocked from said second transmission member when in the release state.

9. The power gain machine as claimed in claim 8, wherein:
said first power gain device includes a first gear;
said control device further includes a fixed ring sleeved fixedly on said pivot shaft and disposed between said first gear and said first transmission member, and a first detecting member disposed on said fixed ring for detecting the rotational speed and angle of said first power gain device, said first detecting member being provided with a coupling gear meshing with said first gear.

10. The power gain machine as claimed in claim 9, wherein:
said first transmission member is disposed between said fixed ring and said second power gain device;
said second power gain device is provided with a plurality of first magnets arranged along a circle; and
said power gain machine further comprises a rotary disk sleeved rotatably on said pivot shaft and disposed between said fixed ring and said first transmission member, said rotary disk including a plurality of second magnets arranged along a circle and aligned respectively with said first magnets of said second power gain device so as to create a magnetic attractive force between said first and second magnets, thereby allowing for co-rotation of said rotary disk with said second power gain device.

11. The power gain machine as claimed in claim 10, wherein:
said rotary disk includes a second gear; and
said control device further includes a second detecting member for detecting the rotational speed and angle of said second power gain device, said second detecting member being provided with a coupling gear meshing with said second gear.

12. The power gain machine as claimed in claim 10, wherein said rotary disk is made of a plastic steel material, and said first transmission member is made of stainless steel.

13. The power gain machine as claimed in claim 8, wherein:
said third power gain device includes a third gear; and
said control device further includes a third detecting member for detecting the rotational speed and angle of said third power gain device, said third detecting member being provided with a coupling gear meshing with said third gear.

14. The power gain machine as claimed in claim 7, wherein:
said driving device includes three pairs of brake shoes, each pair of said brake shoes being diametrically opposite to each other; and
said inner clutch of each of said first, second, and third power gain devices includes a brake ring disposed around a corresponding pair of said brake shoes, and a pushing member movable between at least one engagement position whereat said brake ring is pressed against the corresponding pair of said brake shoes by said pushing member, and a disengagement position whereat said brake ring is removed from the corresponding pair of said brake shoes by said pushing member.

15. The power gain machine as claimed in claim 14, wherein:
each of said first, second, and third power gain devices includes a plate body sleeved rotatably on said pivot shaft;
said brake ring of each of said first, second, and third power gain devices includes an outer peripheral surface, and a plurality of sliding blocks projecting from said outer peripheral surface; and
said inner clutch of each of said first, second, and third power gain devices further includes a plurality of positioning members for retaining movably said sliding blocks of a corresponding one of said first, second, and third power gain devices on said plate body of the corresponding one of said first, second, and third power gain devices.

16. The power gain machine as claimed in claim 15, wherein said inner clutch of each of said first, second, and third power gain devices further includes a first gear unit connected to said pushing member of said inner clutch of the corresponding one of said first, second, and third power gain devices, and a first motor for driving said first gear unit to thereby move said pushing member relative to the corresponding pair of said brake shoes.

17. The power gain machine as claimed in claim 16, wherein said inner clutch of each of said first, second, and third power gain devices further includes a mounting frame that is disposed fixedly on said plate body of the corresponding one of said first, second, and third power gain devices and that is formed with a threaded hole, said pushing member of each of said first, second, and third power gain devices having an externally threaded section engaging said threaded hole in said mounting frame of the corresponding one of said first, second, and third power gain devices.

18. The power gain machine as claimed in claim 17, wherein each of said first, second, and third power gain devices further includes:
an air reservoir;
an air pump in fluid communication with said air reservoir for forcing air into said air reservoir;
a first electromagnetic valve disposed between said air reservoir and said first motor of the corresponding one of said first, second, and third power gain devices and operable to control flow of air from said air reservoir into said first motor of the corresponding one of said first, second, and third power gain devices; and
a carbon brush electrically connected to said air pump and said first electromagnetic valve.

19. The power gain machine as claimed in claim 18, wherein said control device further includes:
a first conductive terminal unit in contact with said carbon brush of said first power gain device; and
a first conductive wire electrically connected to and disposed between said first conductive terminal unit and said control unit.

20. The power gain machine as claimed in claim 18, wherein said control unit further includes:
a second conductive terminal unit in contact with said carbon brush of said second power gain device;
a conductive carbon brush disposed on said second transmission member;
a second conductive wire electrically connected to and disposed between said second conductive terminal unit and said carbon brush of said conductive carbon brush;
a third conductive terminal unit in contact with said conductive carbon brush; and
a third conductive wire electrically to and disposed between said third conductive terminal unit and said control unit.

21. The power gain machine as claimed in claim 20, wherein said control unit further includes:
a fourth conductive terminal unit in contact with said carbon brush of said third power gain device;
a fourth conductive wire electrically connected to and disposed between said fourth conductive terminal unit and said control unit.

22. The power gain machine as claimed in claim 8, wherein said rotating device includes a surrounding wall, each of said first, second, and third power gain devices including an outer clutch convertible between a locking state and a release state, said outer clutch of each of said first and second power gain devices being locked to said surrounding wall when in the locking state, and unlocked from said surrounding wall when in the release state.

23. The power gain machine as claimed in claim 22, wherein:
said surrounding wall of said rotating device has an inner surface formed with three annular grooves spaced apart from each other; and
said outer clutch of each of said first, second, and third power gain devices includes two braking members that are movable away from each other to press against a wall defining a corresponding one of said annular grooves when said outer clutch of a corresponding one of said first, second, and third power gain devices is converted from the release state into the locking state and that are movable toward each other to separate from the wall defining the corresponding one of said annular grooves when said outer clutch of the corresponding one of said first, second, and third power gain devices is converted from the locking state into the release state.

24. The power gain machine as claimed in claim 23, wherein:
each of said first, second, and third power gain devices includes two mounting seats fixed relative to each other; and
each of said braking members includes a sliding seat disposed movably on a corresponding one of said mounting seats of a corresponding one of said first, second, and third poser gain devices, and a brake plate disposed on said sliding seat and movable to press against the wall defining a corresponding one of said annular grooves.

25. The power gain machine as claimed in claim 24, wherein said sliding seat of each of said braking members includes:
a body movable relative to a corresponding one of said mounting seats of a corresponding one of said first, second, and third power gain devices; and
a sliding plate disposed movably on said body and mounted with a corresponding one of said brake plates.

26. The power gain machine as claimed in claim 25, wherein
said body is formed with a dovetail groove, said dovetail groove being defined by a bottom wall, which is spaced apart from the wall defining a corresponding one of said annular grooves by a distance reducing gradually in a predetermined direction;
said sliding plate has a thicker first end, a thinner second end opposite to and thinner than said thicker first end, and a dovetail tongue disposed slidably within said dovetail groove, and a tapered brake-mounting portion connected integrally to said dovetail tongue and disposed outwardly of said body, said having a thickness reducing gradually from said thicker first end to said thinner second end in said predetermined direction; and
each of said braking members further includes a spring connected between said body and said sliding plate for biasing said sliding plate to move relative to said body in said predetermined direction.

27. The power gain machine as claimed in claim 24, wherein:
each of said mounting seats of each of said first, second, and third power gain devices is formed with a threaded hole;
each of said first, second, and third power gain devices includes a plate body; and
said outer clutch of each of said first, second, and third power gain devices further includes:
a driving rod journalled on said plate body of a corresponding one of said first, second, and third power gain devices,
two first driving gears sleeved respectively and fixedly on two opposite ends of said driving rod;
two driven rods each having one end journalled on said plate body of the corresponding one of said first, second, and third power gain devices, and the other end having an externally threaded portion engaging said threaded hole in a corresponding one of said mounting seats of the corresponding one of said first, second, and third power gain devices;
two second driving gears sleeved respectively and fixedly on said driven rods and meshing respectively with said first driving gears, so that rotation of said driving rod can be transferred to said driven rods, thereby rotating and moving said driving rods relative to said mounting seats, respectively; and
a second motor controlled by said control device to rotate said driving rod and, thus, said driven rods.

28. The power gain machine as claimed in claim 27, wherein said outer clutch of each of said first, second, and third power gain devices further includes a second gear unit connected between said driving rod and said second motor and driven by said second motor to rotate said driving rod.

29. The power gain machine as claimed in claim 28, wherein each of said first, second, and third power gain devices further includes:
an air reservoir;
an air pump in fluid communication with said air reservoir for forcing air into said air reservoir;
a first electromagnetic valve disposed between said air reservoir and said first motor of the corresponding one of said first, second, and third power gain devices and operable to control flow of air from said air reservoir into said first motor of the corresponding one of said first, second, and third power gain devices, and
a carbon brush connected between said air pump and said first electromagnetic valve.

30. The power gain machine as claimed in claim 29, wherein said control device further includes:
a second conductive terminal unit in contact with said carbon brush of said second power gain device;
a conductive carbon brush disposed on said second transmission member;
a second conductive wire electrically connected to and disposed between said second conductive terminal unit and said carbon brush of said conductive carbon brush;
a third conductive terminal unit in contact with said conductive carbon brush; and
a third conductive wire electrically to and disposed between said third conductive terminal unit and said control unit.

31. The power gain machine as claimed in claim 30, wherein said control unit further includes:
a fourth conductive terminal unit in contact with said carbon brush of said third power gain device;
a fourth conductive wire electrically connected to and disposed between said fourth conductive terminal unit and said control unit.

32. The power gain machine as claimed in claim 8, wherein said driving device further includes:
a driving motor disposed on said base;
a main driving gear connected to and driven by said driving motor; and
a main driven gear connected fixedly to said first and second transmission members and meshing with said main driving gear such that rotation of said main driving gear can be transferred to said first and second transmission members.

33. The power gain machine as claimed in claim 11, wherein:
said pivot shaft is formed with a guiding hole;
said fixed ring is formed with a through hole; and
said control unit further includes a pair of first and second transmission lines extending through said guiding hole and said through hole for respectively and electrically connecting said first and second detecting members to said control unit.

34. The power gain machine as claimed in claim 33, wherein said control device further includes a third transmission line electrically connecting said third detecting member to said control unit.

35. A power gain machine comprising:
a base;
a driving device disposed on said base;
a rotating device disposed rotatably on said base;
two power gain devices disposed rotatably on said base and locked releasably on said driving device and said rotating device such that, each of said power gain devices is driven by said driving device to rotate relative to said base when locked to said driving device; and
a control device for controlling operation of said devices in an alternating cycling mode such that: each of said power gain devices is locked to one of said driving device and said rotating device and is unlocked from the other of said driving device and said rotating device at any time during the alternating cycling mode; said power gain devices are alternately unlocked from said driving device at a first angular position at different times so that each of said power gain devices can rotate downwardly from said first angular position to a second angular position disposed below said first angular position by gravity when locked to said rotating device; said power gain devices are alternately locked to said driving device at said second angular position at different times; and just before one of said power gain devices locked to said rotating device reaches said second angular position, the other of said power gain devices is rotated to said first angular position.

36. A method for controlling the operation of a power gain machine, comprising the steps of:
(A) in an alternating cycling mode, rotating a first power gain device to a first angular position by means of a driving device such that the first power gain device is locked to the driving device and unlocked from a rotating device, simultaneously allowing a second power gain device to rotate downwardly to an exchanging position by gravity such that the second power gain device is unlocked from the driving device and locked to the rotating device, and simultaneously co-rotating a third power gain device with the first power gain device such that the third power gain device is locked to the driving device and unlocked from the rotating device;
(B) unlocking the first power gain device from the driving device, and locking the first power gain device to the rotating device so as to allow the first power gain device to rotate downwardly from the first angular position by gravity;
(C) adjusting the speed of a driving motor of the driving device such that, when the second power gain device reaches a second angular position, the third power gain device is rotated to a balance position to thereby align with the second power gain device, thus maintaining the second and third power gain devices in a balance state;
(D) locking the second gain device to the driving device and unlocking the second gain device from the rotating device; and
(E) rotating the second and third power gain devices for a predetermined revolutions by means of the driving device such that, just before the first power gain device reaches the exchanging position, the speed of the driving motor of the driving device is adjusted to allow the third power gain device to rotate to the first angular position when the first power gain device reaches the exchanging position.

37. The method as claimed in claim 36, before said step (C), further comprising a step of detecting the rotational speeds and angles of the first, second, and third power gain devices such that, in said step (C), the rotational speed of the driving device is adjusted according to the detecting result.

38. The method as claimed in claim 37, wherein:
in said step (A), the first angular position is 12:30 o'clock position, and the exchanging position is 5:00 o'clock position; and
in said step (C), the second angular position is 6:00 o'clock position, and the balance position is 12:00 o'clock position.

39. The method as claimed in claim 37, after said step (E), further comprising a step (F) of, in a power-off mode, adjusting the speed of the driving motor of the driving device so as to allow the first, second, and third power gain devices to rotate to three positions, respectively, in which any two adjacent ones of the first, second, and third power gain devices are spaced apart from each other by an angle of 120°.

40. The method as claimed in claim 37, after said step (F), further comprising a step (G) of locking the first, second, and third power gain devices to both the driving device and the rotating device.

41. The method as claimed in claim 37, after said step (F), further comprising a step (G) of stopping the driving device.
